(19) United States
(12) Patent Application Publication
(10) Pub. No.: US 2020/0060240 A1
(43) Pub. Date: Feb. 27, 2020

(54) DISPLAY CONTROL DEVICE, DISPLAY CONTROL METHOD, AND PROGRAM

(71) Applicant: SONY CORPORATION, TOKYO (JP)

(72) Inventors: MASAKAZU YAJIMA, KANAGAWA (JP); SHOGO KAWATA, TOKYO (JP); MARI SAITO, KANAGAWA (JP); YOSHIYASU KUBOTA, KANAGAWA (JP); TOMOYA ONUMA, SHIZUOKA (JP); CHISAKO KAJIHARA, TOKYO (JP); AKIHIRO MUKAI, CHIBA (JP)

(21) Appl. No.: 16/346,423

(22) PCT Filed: Oct. 6, 2017
(86) PCT No.: PCT/JP2017/036437

§ 371 Date: Apr. 30, 2019

(30) Foreign Application Priority Data
Nov. 29, 2016 (JP) 2016-231234

(51) Int. Cl. A01K 29/00; A01K 11/00; G06K 9/78; G06Q 10/06; G06Q 50/02

(52) U.S. Cl. CPC A01K 29/005; A01K 11/006; G06Q 50/02; G06Q 10/063114; G06K 9/78

(57) ABSTRACT

[Object] It is desirable to provide a technique capable of managing target objects more easily.

[Solution] There is provided a display control device, including: a display control unit configured to perform control such that an image corresponding to a state of a management target object located in a field of view of a user is displayed at a position having a predetermined positional relation with a position of the management target object. In a case in which the image is selected, the display control unit controls guidance display of guiding the user to visually recognize a confirmation part corresponding to the state in the management target object.

### TECHNICAL FIELD

The present disclosure relates to a display control device, a display control method, and a program.

### BACKGROUND ART

In recent years, various techniques have been known as techniques for managing a target object. For example, a technique for managing a farm animal which is an example of a target object is known. Further, various techniques have been disclosed as techniques for managing farm animals. For example, a technique for managing farm animals using position information from a Global Navigation Satellite System (GNSS) has been disclosed (for example, see Patent Literature 1).

### CITATION LIST

### Patent Literature

Patent Literature 1: JP 2008-73005A

### DISCLOSURE OF INVENTION

### Technical Problem

However, it is desirable to provide a technique capable of managing target objects more easily.

### Solution to Problem

According to the present disclosure, there is provided a display control device, including: a display control unit configured to perform control such that an image corresponding to a state of a management target object located in a field of view of a user is displayed at a position having a predetermined positional relation with a position of the management target object. In a case in which the image is selected, the display control unit controls guidance display of guiding the user to visually recognize a confirmation part corresponding to the state in the management target object.

According to the present disclosure, there is provided a display control method, including: performing, by a processor, control such that an image corresponding to a state of a management target object located in a field of view of a user is displayed at a position having a predetermined positional relation with a position of the management target object; and controlling, in a case in which the image is selected, guidance display of guiding the user to visually recognize a confirmation part corresponding to the state in the management target object.

According to the present disclosure, there is provided a program causing a computer to function as a display control device including a display control unit configured to perform control such that an image corresponding to a state of a management target object located in a field of view of a user is displayed at a position having a predetermined positional relation with a position of the management target object. In a case in which the image is selected, the display control unit controls guidance display of guiding the user to visually recognize a confirmation part corresponding to the state in the management target object.

### Advantageous Effects of Invention

As described above, according to the present disclosure, a technique capable of managing target objects more easily is provided. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a configuration example of a display control system according to an embodiment of the present disclosure.

FIG. 2 is a block diagram illustrating a functional configuration example of a communication terminal according to the embodiment.

FIG. 3 is a block diagram illustrating a functional configuration example of a server according to the embodiment.

FIG. 4 is a block diagram illustrating a functional configuration example of an external sensor according to the embodiment.

FIG. 5 is a block diagram illustrating a functional configuration example of a wearable device according to the embodiment.

FIG. 6 is a diagram illustrating an example of display by a communication terminal used by a farmer.

FIG. 7 is a diagram illustrating a first modified example of display by a communication terminal used by a farmer.

FIG. 8 is a diagram illustrating a second modified example of display by a communication terminal used by a farmer.

FIG. 9 is a diagram illustrating a third modified example of display by a communication terminal used by a farmer.

FIG. 10 is a diagram for describing a selection example of an icon corresponding to a state “abnormality confirmation.”

FIG. 11 is a diagram illustrating an example of a field of view of a farmer after selecting an icon corresponding to a state “abnormality confirmation.”

FIG. 12 is a diagram for describing a selection example of an icon corresponding to a state “estrus confirmation.”

FIG. 13 is a diagram illustrating an example of a field of view of a farmer after selecting an icon corresponding to a state “estrus confirmation.”

FIG. 14 is a diagram illustrating an example of a field of view of a farmer including a vulva of a cow corresponding to a state “estrus confirmation.”

FIG. 15 is a diagram for describing a selection example of an icon corresponding to a state “periodic measurement.”

FIG. 16 is a diagram illustrating an example of a field of view of farmer K after selecting an icon corresponding to a state “periodic measurement.”

FIG. 17 is a diagram illustrating an example of a field of view of a farmer including a part in which a BCS of a cow corresponding to a state “periodic measurement” can be measured.

FIG. 18 is a diagram illustrating a display example of a first BCS measurement result.

FIG. 19 is a diagram illustrating an example of a field of view of a farmer including another part in which a BCS of a cow corresponding to a state “periodic measurement” can be measured.

FIG. 20 is a diagram illustrating a display example of a second BCS measurement result.

FIG. 21 is a diagram illustrating an example of a designation manipulation for displaying basic information of a cow.

FIG. 22 is a diagram illustrating another example of a designation manipulation for displaying basic information of a cow.

FIG. 23 is a diagram illustrating a display example of basic information of a cow.

FIG. 24 is a diagram illustrating an example of display by a communication terminal used by a veterinarian.

FIG. 25 is a diagram illustrating an example of field of view of a veterinarian after selecting an icon corresponding to a state “abnormality confirmation.”

FIG. 26 is a diagram illustrating an example of a field of view of a veterinarian including a vulva of a cow corresponding to a state “estrus confirmation.”

FIG. 27 is a diagram illustrating an example of map display.

FIG. 28 is a diagram illustrating an example in which map display and AR display are simultaneously performed.

FIG. 29 is a flowchart illustrating an example of an operation of a server according to an embodiment of the present disclosure.

FIG. 30 is a flowchart illustrating an example of an overall operation of a communication terminal according to the embodiment.

FIG. 31 is a flowchart illustrating an example of an operation of an abnormality confirmation process by a communication terminal according to the embodiment.

FIG. 32 is a flowchart illustrating an example of an operation of an estrus confirmation process by a communication terminal according to the embodiment.

FIG. 33 is a flowchart illustrating an example of an operation of a periodic measurement process by a communication terminal according to the embodiment.

FIG. 34 is a flowchart illustrating an example of an operation of a display control system according to the embodiment.

FIG. 35 is a block diagram illustrating a hardware configuration example of a communication terminal according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, in the present specification and the drawings, structural elements that have substantially the same or similar function and structure are sometimes distinguished from each other using different numbers after the same reference sign. However, when there is no need in particular to distinguish structural elements that have substantially the same or similar function and structure, the same reference sign alone is attached. Further, there are cases in which similar structural elements of different embodiments are distinguished by adding the same reference numeral followed by different letters. However, in a case where it is not necessary to particularly distinguish each of similar structural element, only the same reference signs are attached.

Further, the description will proceed in the following order.

### 0. Overview

1. Embodiment of the present disclosure
1.1. System configuration example
1.2. Functional configuration example of communication terminal
1.3. Functional configuration example of server
1.4. Functional configuration example of external sensor
1.5. Functional configuration example of wearable device
1.6. Details of functions of display control system
1.6.1. Communication terminal used by farmer
1.6.2. Communication terminal used by veterinarian
1.6.3. Map display
1.6.4. Operation examples
1.7. Hardware configuration example

### 2. Conclusion

### 0. OVERVIEW

In recent years, various techniques have been known as techniques for managing a target object. For example, a technique for managing a farm animal which is an example of a target object is known. Further, various techniques have been disclosed as techniques for managing farm animals. For example, a technique for managing farm animals using position information from a Global Navigation Satellite System (GNSS) has been disclosed (for example, see JP 2008-73005A). However, it is desirable to provide a technique capable of managing target objects more easily.

As an example, in the case of farm animals such as milk cows, there are cases in which a breeding headcount exceeds 100, and there are also cases in which a breeding headcount exceeds 1000. Therefore, in the case of farm animals such as milk cows, it is necessary to manage a plurality of farm animals as a group (group management is necessary). In the following description, farm animals (in particular, cows, which are farm animals) will be described as management target objects to be managed as a group, but target management objects to be managed as a group are not limited to farm animals. For example, the management target objects to be managed as a group may be living objects other than farm animals (for example, human beings or the like) or non-living objects (for example, mobile objects such as robots or vehicles).

Further, in this specification, a case in which a group of cows is located in an indoor farm is mainly assumed. However, a place in which a group of cows is located is not limited to an indoor farm. For example, a group of cows may be located in an outdoor farm. Further, in this specification, a case in which a user is a farmer who performs work on a cow and a case in which the user is a veterinarian who examines a state of a cow are mainly assumed. However, the user is not limited to a farmer, and the user is not limited to a veterinarian.

Here, as an example, a case in which a farmer specifies a cow with a bad state (for example, a health state or the like) from a group of cows and desires to perform work on the specified cow or calls a veterinarian for the specified cow to be examined by the veterinarian or the like is assumed. In this case, if the states of all the cows included in the group of cows are to be displayed on a portable terminal or the like, since the states of all the cows are displayed in a very complicated way, it may be difficult to specify a cow. Further, even in a case in which a cow can be specified, it may be difficult to perform confirmation corresponding to a state of the cow.

In this regard, in this specification, a technique through which a cow can be easily specified from a group of cows will be described. Further, in this specification, a technique through which confirmation corresponding to a state of a cow can be easily performed will be described. Further, in a case in which a farmer takes care of a farm animal, the hands of the farmer often get dirty. For this reason, in a case in which a farmer takes care of a farm animal, it may be difficult for the farmer to perform a manipulation using a touch panel. In this regard, in this specification, a technique capable of enabling a farmer to easily perform a manipulation without using her or his hands will be described as well.

The overview of the embodiment of the present disclosure has been described above.

### 1. EMBODIMENT OF THE PRESENT DISCLOSURE

### 1.1. System Configuration Example

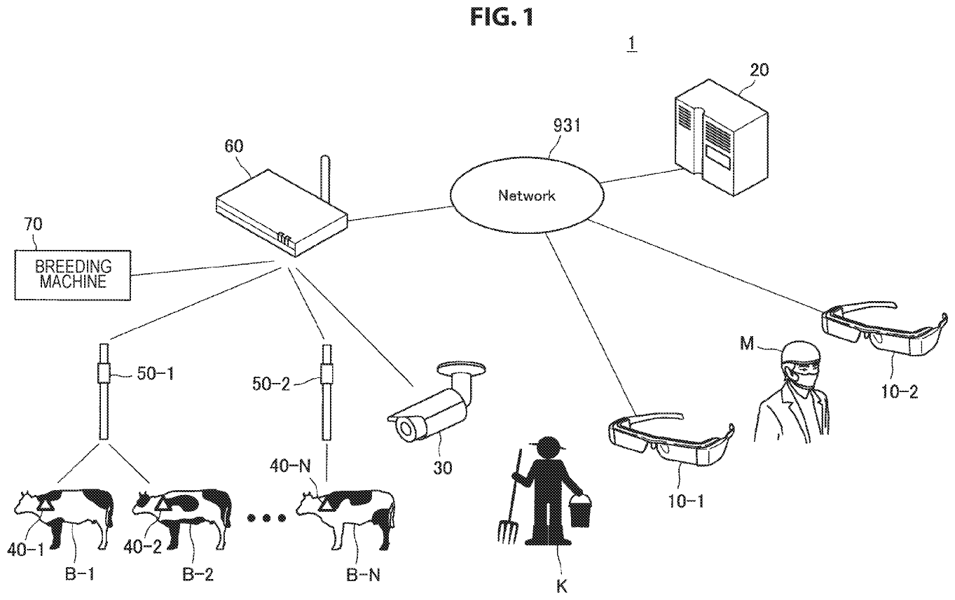

Next, a configuration example of a display control system according to an embodiment of the present disclosure will be described with reference to the appended drawings. FIG. 1 is a diagram illustrating a configuration example of a display control system according to an embodiment of the present disclosure. As illustrated in FIG. 1, a display control system 1 includes a display control device (hereinafter also referred to as a “communication terminal”) 10-1, a display control device (hereinafter also referred to as a “communication terminal”) 10-2, a server 20, an external sensor 30, wearable devices 40-1 to 40-N, repeaters 50-1 and 50-2, a gateway device 60, a breeding machine 70, and a network 931.

In this specification, a case in which the network 931 is a wireless local area network (LAN) is mainly assumed, but as will be described later, a type of network 931 is not limited. Further, the repeater 50 (the repeaters 50-1 and 50-2) relays communication between the wearable device 40 (the wearable devices 40-1 to 40-N) and the server 20. In the example illustrated in FIG. 1, the number of repeaters 50 is two, but the number of repeaters 50 is not limited to two and is preferably two or more. The gateway device 60 connects the network 931 with the repeater 50 (the repeaters 50-1 and 50-2) and the external sensor 30.

The communication terminal 10-1 is a device used by a farmer K. The farmer K is a breeder breeding cows B-1 to B-N(N is an integer of 2 or more). The communication terminal 10-1 is connected to the network 931 and displays an image (hereinafter also referred to as an “icon”) in accordance with a position of a cow located in the field of view of the farmer K and performs transmission and reception of necessary information with the server 20 appropriately, and thus the farmer K can smoothly manage the cows. The icon may be stored by the communication terminal 10-1 or may be stored by the server 20.

Further, in this specification, in consideration of allowing the farmer K to efficiently perform manual labor, a case in which the communication terminal 10-1 is a type of device that is worn by the farmer K (for example, a glasses type, head-mounted display) is assumed. However, the communication terminal 10-1 may be a type of device which is not worn by the farmer K (for example, a smartphone, a panel display mounted on a wall, or the like). Further, in this specification, a case in which the communication terminal 10-1 is a see-through type device is assumed. However, the communication terminal 10-1 may be a non-see-through type device.

The communication terminal 10-2 is a device used by a veterinarian M. The veterinarian M treats an injury or illness of the cows B-1 to B-N. The communication terminal 10-2 is connected to the network 931 and can perform various types of communication and information sharing with the communication terminal 10-1 used by the farmer K via the server 20. For example, the communication terminal 10-2 is capable of making a call with the communication terminal 10-1 used by the farmer K, and is capable of seeing a check result list of registered cows on the basis of a manipulation of the farmer K. The veterinarian M confirms the necessity of taking care of the cow by the farmer K in accordance with a request by a call from the farmer K or by seeing the check result check list, goes to a ranch of the farmer K and conducts medical practice.

Further, in this specification, in consideration of allowing the veterinarian M to efficiently perform manual labor, a case in which the communication terminal 10-2 is a type of device that is worn by the veterinarian M (for example, a glasses type, head-mounted display) is assumed. However, the communication terminal 10-2 may be a type of device which is not worn by the veterinarian M (for example, a smartphone, a panel display mounted on a wall, or the like). Further, in this specification, a case in which the communication terminal 10-2 is a see-through type device is assumed. However, the communication terminal 10-2 may be a non-see-through type device.

The external sensor 30 is a sensor not directly attached to the body of a cow B (cows B-1 to B-N). In this specification, a case in which the external sensor 30 is a surveillance camera is mainly assumed, but the external sensor 30 is not limited to the surveillance camera. For example, the external sensor 30 may be a drone equipped with a camera. Further, in this specification, a case in which an image (hereinafter also referred to as an “overhead image”) is obtained by capturing an overhead image of a part or whole of the cow B (the cows B-1 to B-N) by the external sensor 30 is mainly assumed. However, the direction of the external sensor 30 is not limited.

Further, in this specification, a case in which the external sensor 30 is a visible light camera is mainly assumed. However, a type of external sensor 30 is not limited. For example, the external sensor 30 may be an infrared thermography camera. In a case in which the external sensor 30 is an infrared thermography camera, it is possible to measure a body surface temperature of a cow from an image captured by the infrared thermography camera. Alternatively, the external sensor 30 may be any other type of camera such as a depth sensor capable of acquiring three-dimensional data of a space. The image obtained by the external sensor 30 is transmitted from the external sensor 30 to the server 20 via the gateway device 60 and the network 931.

Further, in addition to the camera, the external sensor 30 may include environmental sensors such as an outside air temperature sensor and a humidity sensor. Values measured by the environmental sensors are transmitted to the server 20 as measurement values.

The server 20 is a device that performs various types of information processing for managing the cow B (the cows B-1 to B-N). Specifically, the server 20 stores information (hereinafter also referred to as “cow information”) in which individual information (including identification information), position information, and the wearable device ID of the cow B (the cows B-1 to B-N) are associated with each other, and performs a reading process if necessary. The identification information may include individual identification information assigned from a country, an identification number of an Internet of Things (IOT) device, an ID assigned by the farmer K, or the like. Then, the server 20 updates the cow information and reads the cow information if necessary.

The individual information includes basic information (identification information, a name, a date of birth, a sex, or the like), health information (a body length, a weight, a medical history, a treatment history, a pregnancy history, a health level, a breeding history, or the like), activity information (an exercise history or the like), harvest information (a yield history, milk components, or the like), a state (a current situation, information related to work required by a cow, or the like), a schedule (a treatment schedule, a birthing schedule, or the like), a sensor data log, and the like. Examples of the information related to the work required by the cow (hereinafter also referred to as “work content”) include periodic measurement, abnormality confirmation, estrus confirmation, and the like (in addition, injury confirmation, pregnancy confirmation, physical condition confirmation, and the like). Further, examples of the current situation include a current place (grazing, a cowshed, milking, or waiting for milking).

The individual information can be input and updated manually by the farmer K or automatically. For example, the farmer K can determine whether a physical condition of the cow is good or bad by visually observing the state of the cow and input information indicating whether the determined physical condition of the cow is good or bad. A health state on the server 20 is updated depending on whether the physical condition of the cow is good or bad which is input by the farmer K. On the other hand, the veterinarian M can examine the cow and input a diagnosis result. The health state on the server 20 is updated in accordance with the diagnosis result input by the veterinarian M.

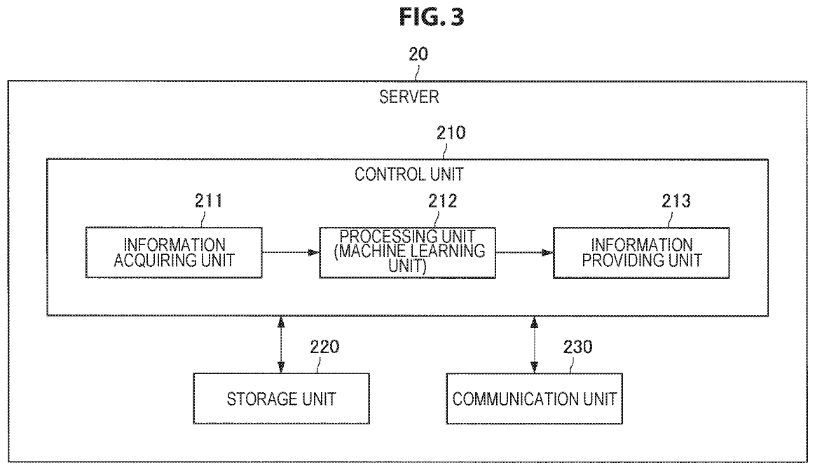

The server 20 can estimate the state of the cow. For example, the server 20 receives a sensor ID and sensor data from the wearable device 40 and the external sensor 30, and estimates the state of each cow by performing a process based on a predetermined algorithm or a machine learning process on the sensor data through a processing unit (machine learning control unit) 212 (FIG. 3). For example, the server 20 estimates a state indicating that a cow whose body temperature has rapidly increased has an infectious disease or estimates a state indicating that a cow whose activity amount has suddenly increased has an estrus sign. Further, the server 20 may estimate a state such as estrus from breeding information such as an estrus history collected so far in addition to the sensor data or may estimate a state on the basis of a combination of the sensor data and cow information (data in a database).

Further, in this specification, a case in which the cow information is stored in the server 20 is mainly assumed. However, a location in which the cow information is stored is not limited. For example, the cow information may be stored in a server different from the server 20. Alternatively, the cow information may be stored in the communication terminal 10.

The wearable device 40 (40-1 to 40-N) includes a communication circuit, a sensor, a memory, and the like, and is attached to the body of a corresponding cow B (cow B-1 to cow B-N). The sensor may include an activity amount sensor, a body temperature sensor, a meal amount measuring sensor that measures the number of ruminations or may have any other sensor. The wearable device 40 (40-1 to 40-N) may use a secondary battery as a power source or may be driven using self-power generation using electric power of a solar cell or vibration power generation as at least a part thereof as a power source.

A shape of the wearable device 40 is not particularly limited. For example, the wearable device 40 may be a tag type device. Further, the wearable device 40 transmits an identification number of the IOT device of the corresponding cow B, the sensor data (for example, information specifying the position information), and a wearable device ID to the server 20 via the repeater 50-1, the repeater 50-2, the gateway device 60, and the network 931. Here, various types of information are assumed as the information specifying the position information of the cow B.

In the specification, the information specifying the position information of the cow B includes a reception strength of a wireless signal transmitted from each of the repeater 50-1 and the repeater 50-2 at predetermined time intervals in the wearable device 40. Then, the server 20 specifies the position information of the wearable device 40 (the cow B) on the basis of the reception strengths and the position information of each of the repeaters 50-1 and 50-2. Accordingly, in the server 20, it is possible to manage the position information of the cow B in real time.

Further, the information specifying the position information of the cow B is not limited to this example. For example, the information specifying the position information of the cow B may include identification information of a relay station which is a transmission source of a wireless signal received by the wearable device 40 among wireless signals transmitted from the repeaters 50-1 and 50-2 at predetermined time intervals. In this case, the server 20 may specify a position of the relay station identified by the identification information of the relay station of the transmission source as the position information of the wearable device 40 (the cow B).

For example, the information specifying the position information of the cow B may include an arrival period of time (a difference between a transmission time and a reception time) of a signal received from each Global Positioning System (GPS) satellite by the wearable device 40. Further, in this specification, a case in which the position information of the cow B is specified in the server 20 is mainly assumed, but the position information of the cow B may be specified in the wearable device 40. In this case, the position information of the cow B may be transmitted to the server 20 instead of the information specifying the position information of the cow B.

Alternatively, the information specifying the position information of the cow B may be an overhead image obtained by the external sensor 30. For example, if the server 20 manages a pattern of the cow B in advance for each individual, it is possible for the server 20 to specify a position of the pattern of the cow B recognized from the overhead image obtained by the external sensor 30 as the position information of the cow B.

Further, identification information (for example, an identification number of the TOT device) is written in the wearable device 40, and the farmer K can comprehend the identification information of the wearable device 40 by looking at the wearable device 40. The wearable device 40 also includes a proximity sensor, and in a case in which the wearable device 40 approaches a specific facility, the proximity sensor can detect the specific facility. With the record of the position information of the wearable device 40 and the information related to the facility which the wearable device 40 approaches, a behavior of the cow can be automatically recorded.

For example, the proximity sensor may be installed at a place where milking is performed as an example of a specific facility, and if the wearable device 40 including a proximity sensor communicating with the proximity sensor is associated with a milking record by an automatic milking machine, a cow producing milk and a produced milk amount can be recorded.

The breeding machine 70 is a machine used for breeding the cows. For example, the breeding machine 70 may be various types of robots such as an automatic feeder, an automatic milking machine, and an automatic livestock barn cleaning machine. The breeding machine 70 can change a feeding amount, the necessity of milking, or the frequency of cleaning in accordance with an instruction command from the server 20 or the communication terminal 10. Further, the automatic milking machine can measure milk components, and a measurement result can be treated as part of external sensor data.

The configuration example of the display control system 1 according to an embodiment of the present disclosure has been described above.

### [1.2. Functional Configuration Example of Communication Terminal]

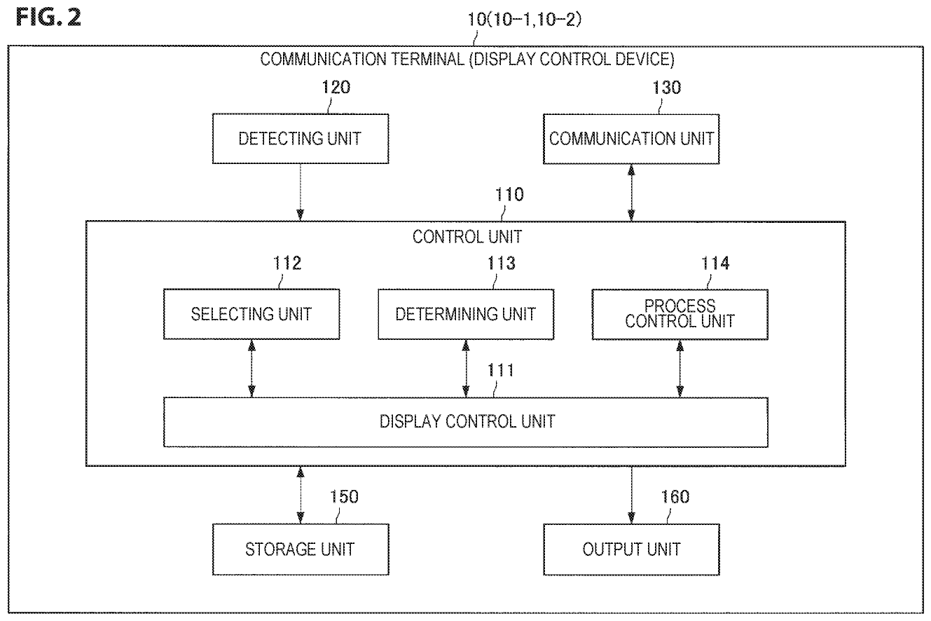

Next, a functional configuration example of the communication terminal 10 according to an embodiment of the present disclosure will be described. FIG. 2 is a block diagram illustrating a functional configuration example of the communication terminal 10 according to an embodiment of the present disclosure. As illustrated in FIG. 2, the communication terminal 10 includes a control unit 110, a detecting unit 120, a communication unit 130, a storage unit 150, and an output unit 160. The functional blocks of the communication terminal 10 will be described below. As illustrated in FIG. 1, in a case in which the communication terminal 10 includes a housing which can be worn on the head of the farmer K, the housing may include these functional blocks. Further, although the functional configuration example of the communication terminal 10-1 used by the farmer K will be mainly described here, the functional configuration of the communication terminal 10-2 used by the veterinarian M can be realized similarly to the functional configuration of the communication terminal 10-1 used by the farmer K.

The control unit 110 controls each unit of the communication terminal 10-1. Further, the control unit 110 may be constituted by a processing device such as one or more central processing units (CPUs). In a case in which the control unit 110 is constituted by a processing device such as a CPU, the processing device may be constituted by an electronic circuit. As illustrated in FIG. 2, the control unit 110 includes a display control unit 111, a selecting unit 112, a determining unit 113, and a process control unit 114. The blocks of the control unit 110 will be described later in detail.

The detecting unit 120 includes one or more sensors, and can detect a direction in which the farmer K in a three-dimensional space is paying attention (hereinafter also referred to simply as a “direction of interest”). In this specification, a case in which a direction of the face of the farmer K (the position of the field of view of the farmer K) is used as the direction of interest will be mainly described. Here, the direction of the face of the farmer K may be detected using any method. As an example, the direction of the face of the farmer K may be a direction of the communication terminal 10-1. The direction of the communication terminal 10-1 may be detected by an axis-of-earth sensor or may be detected by a motion sensor.

The detecting unit 120 can detect the direction indicated by the farmer K in a three-dimensional space (hereinafter also referred to simply as an “indication direction”). In this specification, a case in which the line of sight of the farmer K is used as the indication direction will be mainly described. Here, the line of sight of the farmer K can be detected using any method. As an example, in a case in which the detecting unit 120 includes an image sensor, the line of sight of the farmer K may be detected on the basis of an eye region shown in an image obtained by the image sensor.

The direction of interest or the indication direction may be detected on the basis of a detection result by a motion sensor detecting a motion of the farmer K (an indication direction in which a position in a three-dimensional space detected by a motion sensor is a front may be detected). The motion sensor may detect an acceleration with the acceleration sensor or may detect an angular velocity with a gyro sensor (for example, a ring type gyroscope or the like). Alternatively, the direction of interest or the indication direction may be detected on the basis of a detection result by a tactile device. An example of the tactile device is a pen type tactile device.

Alternatively, the direction of interest or the indication direction may be a direction indicated by a predetermined object (for example, a direction in which a leading end of a stick points) or may be a direction indicated by a finger of the farmer K. In a case in which the detecting unit 120 includes an image sensor, the direction in which the predetermined object points and the direction indicated by the finger of the farmer K may be detected on the basis of an object and a finger shown in an image obtained by the image sensor.

Alternatively, the indication direction may be detected on the basis of a face recognition result of the farmer K. For example, in a case in which the detecting unit 120 has an image sensor, a center position between the eyes may be recognized on the basis of an image obtained by the image sensor, and a straight line extending from the center position between the eyes may be detected as the indication direction.

Alternatively, the direction of interest or the indication direction may be a direction corresponding to speech content of the farmer K. In a case in which the detecting unit 120 includes a microphone, the direction corresponding to the speech content of the farmer K may be detected on the basis of a voice recognition result for sound information obtained by a microphone. For example, in a case in which the farmer K desires to designate an inner side of the field of view as the front in the indication direction, it is sufficient to produce speech indicating the inner side of the field of view (for example, “speech” such as “the cow on the inner side”). Accordingly, text data “the cow on the inner side” is obtained as the voice recognition result for such speech, and the indication direction in which the inner side of the field of view is the front can be detected on the basis of the text data “the cow on the inner side.” Further, the speech content may be “show an overhead image,” “show it from above,” “show the cow on the inner side,” or the like.

Further, the detecting unit 120 can detect various types of manipulations by the farmer K. Further, in this specification, a selection manipulation and a switching manipulation will be mainly described as examples of various types of manipulations by the farmer K. Here, various types of manipulations by the farmer K can be detected through any method. However, since there are cases in which the hands are unable to perform work on a farm animal or the like (cases in which the hands are dirty or the like), various types of manipulations by the farmer K are preferably hands-free manipulations (a manipulation by a non-contact sensor) (it is desirable for the detecting unit 120 to include a non-contact sensor). Specifically, the non-contact sensor may detect at least one of a gesture of the farmer K, the line of sight of the farmer K, or a speech recognition result (a voice command of the farmer K). As an example, the gesture of the farmer K may include a motion of the farmer K.

The detection of the motion of the farmer K can be performed through any method. For example, in a case in which the detecting unit 120 includes an image sensor, the motion of the farmer K may be detected from an image obtained by the image sensor. The motion of the farmer K may be a predetermined motion such as a wink, a motion of clenching an opened hand, a virtual tap gesture, or the like. Alternatively, the detecting unit 120 may detect the motion of the farmer K with a motion sensor. The motion sensor may detect an acceleration with an acceleration sensor or may detect an angular velocity with a gyro sensor.

Alternatively, the gesture of the farmer K may include a position of the body of the farmer K (for example, a position of the head) or may include a posture of the farmer K (for example, a posture of the whole body or the like). Alternatively, various types of manipulations by the farmer K may be detected on the basis of myoelectricity (for example, myoelectricity of a jaw, myoelectricity of an arm, or the like) or may be detected on the basis of an electroencephalogram. Alternatively, various types of manipulations by the farmer K may include a manipulation on a switch, a lever, a button, or the like installed in the communication terminal 10-1 or a controller connected with the communication terminal 10-1 in a wired or wireless manner and a manipulation by a touch sensor such as a touch manipulation on the communication terminal 10-1.

Further, the detecting unit 120 can detect the position information of the communication terminal 10-1 in addition to the direction of the communication terminal 10-1. Here, the position information of the communication terminal 10-1 may be detected through any method. For example, the position information of the communication terminal 10-1 may be detected on the basis of an arrival period of time (a difference between a transmission time and a reception time) of a signal received from each GPS satellite by the communication terminal 10-1. Alternatively, in a case in which the communication terminal 10-1 can receive wireless signals transmitted from the repeaters 50-1 and 50-2 similarly to the wearable devices 40-1 to 40-N, the position information of the communication terminal 10-1 can be detected as well similarly to the position information of the wearable devices 40-1 to 40-N.

Alternatively, the position information of the communication terminal 10-1 may be relative position information of a head mounted display (HMD) measured by a positioning sensor such as a simultaneous localization and mapping (SLAM) camera. Further, the position information of the communication terminal 10-1 may be position information corrected (offset) on the basis of a mounting position of the HMD.

The communication unit 130 includes a communication circuit and has a function of communicating with other devices via the network 931 (FIG. 1). For example, the communication unit 130 is constituted by a communication interface. For example, the communication unit 130 can communicate with the server 20 via the network 931 (FIG. 1).

The storage unit 150 includes a memory and is a recording device that stores a program to be executed by the control unit 110 and data necessary for executing the program. Further, the storage unit 150 temporarily stores data for calculation by the control unit 110. Further, the storage unit 150 may be a magnetic storage device, a semiconductor storage device, an optical storage device, or a magneto-optical storage device.

The output unit 160 outputs various types of information. For example, the output unit 160 may include a display capable of performing display which can be visually recognized by the farmer K, and the display may be a liquid crystal display (the liquid crystal display includes a liquid crystal whose light transmittance changes in accordance with a voltage), or may be an organic electro-luminescence (EL) display (the organic EL display includes an organic substance that emits light in accordance with a predetermined voltage).

Further, the output unit 160 may include an audio output device such as a speaker (the audio output device includes a coil, a magnet, and a diaphragm). Alternatively, the output unit 160 may include a tactile sense presenting device that presents a tactile sense to the farmer K (the tactile presenting device includes an oscillator that vibrates in accordance with a predetermined voltage).

In particular, in work sites for farm animals or the like, a hands-free manipulation is desirable because there are cases in which the hands are unable to be used for work for the farm animals or the like because they are being used for other work. In this regard, the display is desirably a device that can be worn on the head of the farmer K (for example, an HMD). In a case in which the output unit 160 includes a housing which can be worn on the head of the farmer K, the housing may include a display that displays information related to a cow. At this time, the display may be a transmissive display or a non-transmissive display. In a case in which the display is a non-transmissive display, an image captured by an image sensor included in a detecting unit 120 is displayed, and thus the farmer K can visually recognize a space corresponding to the field of view.

The functional configuration example of the communication terminal 10 according to an embodiment of the present disclosure has been described above.

### [1.3. Functional Configuration Example of Server]

Next, a functional configuration example of the server 20 according to an embodiment of the present disclosure will be described. FIG. 3 is a block diagram illustrating a functional configuration example of the server 20 according to an embodiment of the present disclosure. As illustrated in FIG. 3, the server 20 includes a control unit 210, a storage unit 220, and a communication unit 230. The functional blocks of the server 20 will be described below.

The control unit 210 controls each unit of the server 20. Further, the control unit 210 may be constituted by a processing device such as, for example, one or a plurality of CPUs. In a case in which the control unit 210 is constituted by a processing device such as a CPU, the processing device may be constituted by an electronic circuit. As illustrated in FIG. 3, the control unit 210 includes an information acquiring unit 211, a processing unit (machine learning control unit) 212, and an information providing unit 213. The blocks of the control unit 210 will be described later in detail.

The storage unit 220 is a recording device that includes a memory, stores a program to be executed by the control unit 210 or stores data (for example, cow information or the like) necessary for executing a program. Further, the storage unit 220 temporarily stores data for calculation by the control unit 210. Further, the storage unit 220 may be a magnetic storage unit device, a semiconductor storage device, an optical storage device, or a magneto-optical storage device.

The communication unit 230 includes a communication circuit and has a function of communicating with other devices via the network 931 (FIG. 1). For example, the communication unit 230 includes a communication interface. For example, the communication unit 230 can communicate with the communication terminal 10, the external sensor 30, the wearable device 40 (the wearable devices 40-1 to 40-N) and the breeding machine 70 via the network 931 (FIG. 1).

The functional configuration example of the server 20 according to an embodiment of the Present Disclosure has been Described Above.

[1.4. Functional configuration example of external sensor]

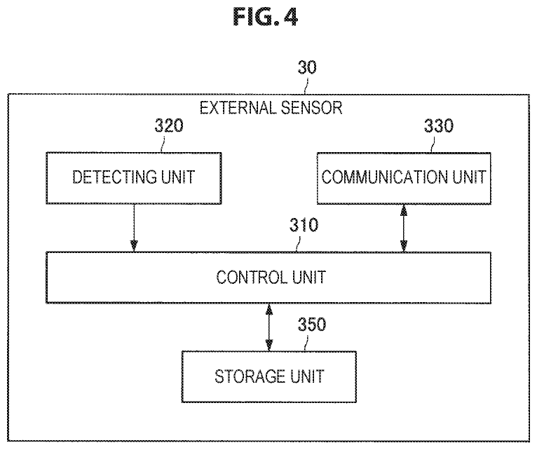

Next, a functional configuration example of the external sensor 30 according to an embodiment of the present disclosure will be described. FIG. 4 is a block diagram illustrating a functional configuration example of the external sensor 30 according to an embodiment of the present disclosure. As illustrated in FIG. 4, the external sensor 30 includes a control unit 310, a detecting unit 320, a communication unit 330, and a storage unit 350. The functional blocks of the external sensor 30 will be described below.

The control unit 310 controls each unit of the external sensor 30. Further, the control unit 310 may be constituted by a processing device such as, for example, one or a plurality of CPUs. In a case in which the control unit 310 is constituted by a processing device such as a CPU, the processing device may be constituted by an electronic circuit.

The detecting unit 320 includes one or more sensors. For example, the detecting unit 320 includes an image sensor and obtains an overhead image by capturing an overhead image of some or all of the cows B (the cows B-1 to B-N). However, a direction (imaging direction) of the image sensor is not limited. Further, the detecting unit 320 may include environmental sensors such as an outside air temperature sensor and a humidity sensor.

The communication unit 330 includes a communication circuit and has a function of communicating with other devices via the network 931 (FIG. 1). For example, the communication unit 330 includes a communication interface. For example, the communication unit 330 can communicate with the server 20 via the network 931 (FIG. 1).

The storage unit 350 includes a memory and is a recording device that stores a program to be executed by the control unit 310 and data necessary for executing the program. Further, the storage unit 350 temporarily stores data for calculation by the control unit 310. Further, the storage unit 350 may be a magnetic storage device, a semiconductor storage device, an optical storage device, or a magneto-optical storage device.

The functional configuration example of the external sensor 30 according to an embodiment of the present disclosure has been described above.

### [1.5. Functional Configuration Example of Wearable Device]

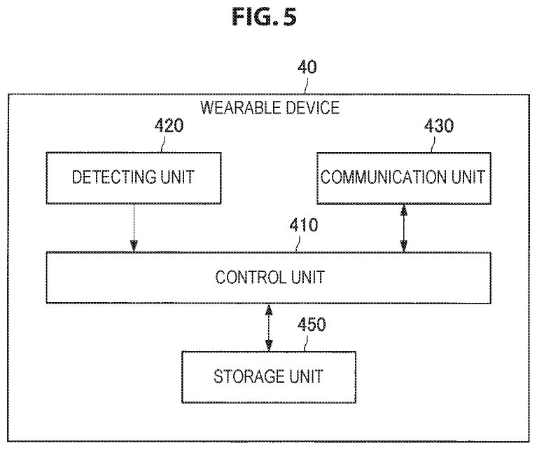

Next, a functional configuration example of the wearable device 40 according to an embodiment of the present disclosure will be described. FIG. 5 is a block diagram illustrating a functional configuration example of the wearable device 40 according to an embodiment of the present disclosure. As illustrated in FIG. 5, the wearable device 40 includes a control unit 410, a detecting unit 420, a communication unit 430, and a storage unit 450. The functional blocks of the wearable device 40 will be described below.

The control unit 410 controls each unit of the wearable device 40. Further, the control unit 410 may be constituted by a processing device such as, for example, one or a plurality of CPUs. In a case in which the control unit 410 is constituted by a processing device such as a CPU, the processing device may be constituted by an electronic circuit.

The detecting unit 420 includes one or more sensors. For example, the detecting unit 420 may have an activity amount sensor. The activity amount sensor may include an acceleration sensor and detect an activity amount on the basis of an acceleration detected by the acceleration sensor. Further, the detecting unit 420 may include a body temperature sensor. Further, the detecting unit 420 may include a meal amount measuring sensor. The meal amount measuring sensor may include a vibration sensor and measure the number of ruminations on the basis of the number of vibrations detected by the vibration sensor.

The communication unit 430 includes a communication circuit and has a function of communicating with other devices via the network 931 (FIG. 1). For example, the communication unit 430 includes a communication interface. For example, the communication unit 430 can communicate with the server 20 via the network 931 (FIG. 1).

The storage unit 450 includes a memory and is a recording device that stores a program to be executed by the control unit 410 and data necessary for executing the program. Further, the storage unit 450 temporarily stores data for calculation by the control unit 410. Further, the storage unit 450 may be a magnetic storage device, a semiconductor storage device, an optical storage device, or a magneto-optical storage device.

The functional configuration example of the wearable device 40 according to an embodiment of the present disclosure has been described above.

### [1.6. Details of Functions of Display Control System]

Next, the functions of the display control system 1 will be described in detail.

### (1.6.1. Communication Terminal Used by Farmer)

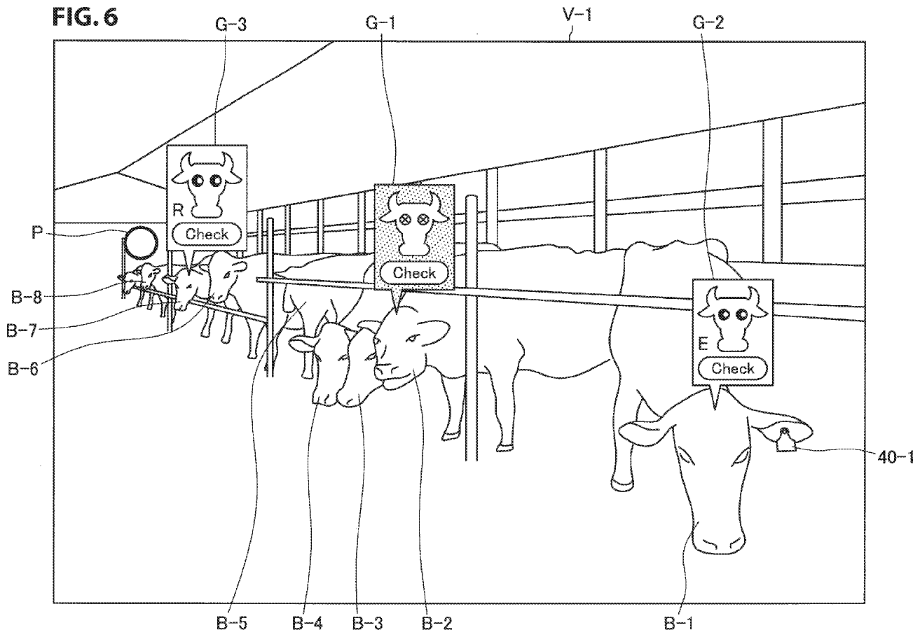

First, functions of the communication terminal 10-1 used by the farmer K will be described mainly. FIG. 6 is a diagram illustrating an example of display by the communication terminal 10-1 used by the farmer K. In the example illustrated in FIG. 6, a case in which the farmer K wearing the communication terminal 10-1 is located in the real world. Referring to FIG. 6, a field of view V-1 of the farmer K is illustrated. Here, the field of view V-1 may simply be a field of view of the farmer K itself, may be a range corresponding to a captured image of a sensor (for example, a camera) of the detecting unit 120, or may be a region which can be viewed through a transparent/non-transparent display.

As illustrated in FIG. 6, the group of cows (the cows B-1 to B-8) is located in the indoor farm, and the group of cows (the cows B-1 to B-8) is located in the field of view V-1 of the farmer K. Further, the number of cows included in the group of cows is not particularly limited. Here, in the communication terminal 10-1 worn by the farmer K, if the detecting unit 120 detects the state (for example, the position information and the direction information) of the communication terminal 10-1, the communication unit 130 transmits the state (the position information and the direction) of the communication terminal 10-1 to the server 20.

In the server 20, if the communication unit 230 receives the state (the position information and the direction) of the communication terminal 10-1, the information acquiring unit 211 decides the group of cows (the cows B-1 to B-M) (M is an integer of 2 or more) which are closely located at a predetermined distance from the position of communication terminal 10-1 (the farmer K) within a predetermined angle range (the field of view V-1 of the farmer K) based on the direction of the communication terminal 10-1 on the basis of the state (the position information and the direction) of the communication terminal 10-1 and the position information of each of the cows B-1 to B-M.

Further, the distance between the position of the communication terminal 10-1 (the farmer K) and the position of each of the cows B-1 to B-N may be calculated by any other technique. For example, in a case in which the communication terminal 10-1 can receive a wireless signal transmitted from the wearable device 40 (the wearable devices 40-1 to 40-M), the determining unit 113 may calculate the distance between the position of the communication terminal 10-1 (the farmer K) and the position of each of the cows B-1 to B-N on the basis of reception strengths of the wireless signals transmitted from the wearable devices 40-1 to 40-M. Alternatively, the distance between the position of the communication terminal 10-1 (the farmer K) and the position of each of the cows B-1 to B-N may be acquired as relative position information on the basis of depth information obtained from an image captured by an image sensor included in the communication terminal 10-1.

In this specification, a case in which the group of cows (the cows B-1 to B-M) are some of the cows B-1 to B-N managed by the server 20 is mainly assumed, but the group of cows (the cows B-1 to B-M) may be all of the cows B-1 to B-N (M may be equal to N). Here, as illustrated in FIG. 6, the group of cows (the cows B-1 to B-8) is located in the field of view V-1 of the farmer K, and the information acquiring unit 211 decides the group of cows (the cows B-1 to B-8) from the group of cows (the cows B-1 to B-N).

If the individual information and the position information of each cow of the group of cows (the cows B-1 to B-8) are acquired by the information acquiring unit 211, the information providing unit 213 provides the individual information and the position information of each cow of the group of cows (the cows B-1 to B-8) to the communication terminal 10-1 via the communication unit 230. In the communication terminal 10-1, the communication unit 130 receives the individual information and the position information of each cow of the group of cows (the cows B-1 to B-8).

Further, here, the example in which the individual information and the position information of each cow of the group of cows (the cows B-1 to B-8) stored in the server 20 are received by the communication terminal 10-1 is illustrated. However, in a case in which the individual information and the position information of each cow of the group of cows (the cows B-1 to B-8) are stored in the storage unit 150 in the communication terminal 10-1, the individual information and the position information of each cow of the group of cows (the cows B-1 to B-8) may be read from the storage unit 150.

The display control unit 111 acquires the state of each cow of the group of cows (the cows B-1 to B-8) from the individual information of each cow of the group of cows (the cows B-1 to B-8). Here periodic measurement, abnormality confirmation, and estrus confirmation are assumed as the state of each cow of the group of cows (the cows B-1 to B-8). However, the state of each cow of the group of cows (the cows B-1 to B-8) is not limited to predetermined states such as the periodic measurement, the abnormality confirmation, and the estrus confirmation. Here, a case in which the state of the cow B-1 is the estrus confirmation, the state of the cow B-2 is the abnormality confirmation, and the state of the cow B-7 is the periodic measurement is assumed.

Further, the periodic measurement indicates a state in which measurement has to be currently performed in a case in which a body condition score (BCS) or the like of a cow is periodically measured. For example, in a case in which a measurement interval is one month, the cow in which one month has passed at a current time point since the last measurement date registered in the cow information (database) is a periodic measurement target. The abnormality confirmation indicates a state in which a health problem such as a disease or an injury is estimated. The estrus confirmation indicates a state in which there is a sign of estrus, and estrus is estimated.

As described above, in the example illustrated in FIG. 6, the state of the cow B-1 is the estrus confirmation. In this regard, the display control unit 111 performs control such that an icon G-2 corresponding to the state “estrus confirmation” of the cow B-1 located in the field of view V-1 of the farmer K is displayed at a position having a predetermined positional relation with the position of the cow B-1. If the icon G-2 corresponding to the state “estrus confirmation” is displayed at a position having a predetermined positional relation with the position of the cow B-1, it is possible to intuitively comprehend that the icon G-2 corresponding to the state “estrus confirmation” corresponds to the cow B-1. For example, in a case in which a state type (state category) “estrus confirmation” is associated with the icon G-2 in advance, the display control unit 111 may control display of the icon G-2 corresponding to the state type “estrus confirmation” category of the cow B-1. Further, in this specification, the display at the position depending on the position of the target object located in the field of view as in this example is also referred to as “AR display.”

FIG. 6 illustrates an example in which the display control unit 111 recognizes the position of the head of the cow B-1 through an image recognition process or the like and performs control such that the icon G-2 is displayed above the head of the cow B-1 in order to prevent the farmer K from seeing the cow B-1 which is the estrus confirmation in the field of view V-1. However, the position at which the icon G-2 is displayed is not limited. For example, the display control unit 111 may recognize the position of the head of the cow B-1 using the position information of the cow B-1 or using the position of the head of the cow B-1 recognized from an image detected by the detecting unit 120 in addition to the position information of the cow B-1.

In addition, the display control unit 111 may cause the icon G-2 to be displayed at a position that is a predetermined distance above the position indicated by the position information of the cow B-1 or may cause the icon G-2 to be displayed on the back of the cow B-1. Alternatively, the display control unit 111 may cause the icon G-2 to be displayed at a position apart from the cow B-1 by a predetermined distance and cause an anchor connecting the icon G-2 and the cow B-1 to be displayed. With this anchor, the farmer K can intuitively comprehend that the icon G-2 corresponds to the cow B-1.

As described above, in the example illustrated in FIG. 6, the state of the cow B-2 is the abnormality confirmation. In this regard, the display control unit 111 performs control such that the icon G-1 corresponding to the state “abnormality confirmation” of the cow B-2 located in the field of view V-1 of the farmer K is displayed at a position having a predetermined positional relation with the position of the cow B-2. If the icon G-1 corresponding to the state “abnormality confirmation” is displayed at a position having a predetermined positional relation with the position of the cow B-2, it is possible to intuitively comprehend that the icon G-1 corresponding to the state “abnormality confirmation” corresponds to the cow B-2. For example, in a case in which the state type (state category) “abnormality confirmation” is associated with the icon G-1 in advance, the display control unit 111 may control display of the icon G-1 corresponding to the state type “abnormality confirmation” category of the cow B-2.

As described above, in the example illustrated in FIG. 6, the state of the cow B-7 is the periodic measurement. In this regard, the display control unit 111 performs control such that an icon G-3 corresponding to the state “periodic measurement” of the cow B-7 located in the field of view V-1 of the farmer K is displayed at a position having a predetermined positional relation with the position of the cow B-7. If the icon G-3 corresponding to the state “periodic measurement” is displayed at a position having a predetermined positional relation with the position of the cow B-7, it is possible to intuitively comprehend that the icon G-3 corresponding to the state “periodic measurement” corresponds to the cow B-7. For example, in a case in which the state type (state category) “periodic measurement” is associated with the icon G-3 in advance, the display control unit 111 may control display of the icon G-3 corresponding to the state type “periodic measurement” category of the cow B-7.

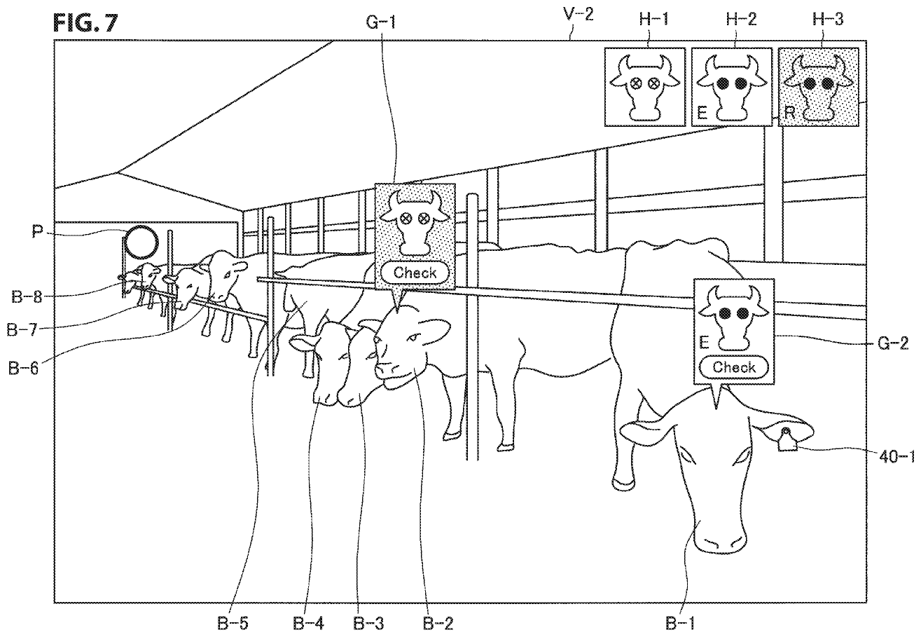

Further, the position at which each of the icon G-1 and the icon G-3 is displayed may be controlled similarly to the position at which the icon G-2 is displayed. In other words, the positional relation between the cow B and the icon G may be constant regardless of the type (state type) of the icon G. Accordingly, the farmer K can easily comprehend a correspondence relation between the cow B and the icon G regardless of the type of the icon G. However, the position of the icon G may be different depending on the type (state type) of the icon G. Further, the display control unit 111 performs control such that an icon is displayed for a cow that satisfies a first condition in the group of cows (the cows B-1 to B-8) and restrict display of an icon for a cow that satisfies a second condition different from the first condition. Accordingly, the farmer K will be able to see only the icon of the cow which is in the state to be confirmed. As an example, the display control unit 111 may perform control such that an icon is displayed for a cow in a predetermined state (the cows B-1, B-2, and B-7 in the example illustrated in FIG. 6) and restrict icon display of a cow in a case in which there is a cow (the cows B-3 to B-6 and B-8 in the example illustrated in FIG. 6) in a state other than the predetermined state (such that an icon is not displayed). As another example, as described with reference to FIG. 7, the display control unit 111 may control icon display corresponding to a state in which display is selected and restrict icon display corresponding to a state in which non-display is selected (such that an icon is not displayed).

FIG. 7 is a diagram illustrating a first modified example of the display by the communication terminal 10-1 used by the farmer K. FIG. 6 illustrates an example of displaying all of the icon G-2 corresponding to the state “estrus confirmation,” the icon G-1 corresponding to the state “abnormality confirmation,” and the icon G-3 corresponding to the state “periodic measurement.” However, the icons G-1 to G-3 may be switchable between the display and the non-display for each state. Accordingly, the farmer K will be able to see only the icon G corresponding to the state which is desired to be confirmed.

For example, a case in which it is difficult to visually recognize the icons G-1 corresponding to the state “abnormality confirmation” and the icon G-2 corresponding to the state “estrus confirmation” or the like since there is a plurality of icons G-3 corresponding to the state “periodic measurement” in the field of view V-2 is assumed. In this case, the icon G-3 corresponding to the state “periodic measurement” may be switched to the non-display. Referring to FIG. 7, a field of view V-2 of the farmer K is illustrated. Further, the icon G-3 corresponding to the state “periodic measurement” is not displayed in the field of view V-2.

It is desirable that the display or the non-display of the icons G-1 to G-3 be easily comprehended by the farmer K. In this regard, the display control unit 111 may control display of information indicating the display or the non-display of the icons G-1 to G-3 (hereinafter also referred to as “display/non-display”) for each state. FIG. 7 illustrates a display/non-display H-1 of the icon G-1, a display/non-display H-2 of the icon G-2, and a display/non-display H-3 of the icon G-3.

In the example illustrated in FIG. 7, since the icon G-1 and the icon G-2 are displayed, the display/non-display H-1 of the icon G-1 and the display/non-display H-2 of the icon G-2 are indicated by a form indicating the display (for example, white). On the other hand, since the icon G-3 is not displayed, the display/non-display H-3 of the icon G-3 is indicated by a form indicating the non-display (for example, black). However, the display states of each of the display and the non-display of the icons G-1 to G-3 are not limited.

The switching between the display and the non-display of the icons G-1 to G-3 may be performed by the display control unit 111 in a case in which a switching manipulation by the farmer K is detected by the detecting unit 120. The variations of the switching manipulation have been described above. For example, a case in which the farmer K matches an indication direction (for example, the line of sight of the farmer K or the like) with the display/non-display H-3 of the icon G-3 and performs the switching manipulation in the state in which the icon G-3 corresponding to the state “periodic measurement” is displayed is assumed. In this case, if the switching manipulation is detected by the detecting unit 120, the display control unit 111 determines that the display/non-display H-3 of the icon G-3 is located in the indication direction of the farmer K detected by the detecting unit 120 and switches the icon G-3 corresponding to the state “periodic measurement” to the non-display.

At this time, in order to make it easy for the farmer K to comprehend the position of indication direction, the display control unit 111 may perform control such that a pointer P is displayed at the position with which the indication direction of the farmer K matches as illustrated in FIG. 7.

Further, the farmer K may match a direction of interest (for example, a direction of the face of the farmer K) with the display/non-display H-3 of the icon G-3. In this case, if the switching manipulation is detected by the detecting unit 120, the display control unit 111 may determine that the display/non-display H-3 of the icon G-3 is located at the position with which the direction of interest detected by the detecting unit 120 matches and set the icon G-3 corresponding to the state “periodic measurement” to the non-display.

At this time, in order to make it easy for the farmer K to comprehend the position in the direction of interest, the display control unit 111 may perform control such that the pointer is displayed at the position with which the direction of interest of the farmer matches. Further, since it is assumed that the direction of interest (for example, the direction of the face of the farmer K) does not change (that the direction of interest does not change in the field of view V-2) in a case in which the communication terminal 10-1 is used as a reference, it is desirable for the display control unit 111 to perform control such that the pointer is displayed at a fixed position (for example, at the center of the field of view V-2 or the like).

Further, here, the switching from the display of the icon G-3 to the non-display has mainly been described. However, switching from the non-display of the icon G-3 to the display may be realized, similarly to the switching from the display of the icon G-3 to the non-display. Further, switching between the display/non-displays of the icon G-1 and the icon G-2 may also be realized, similarly to the switching from the display of the icon G-3 to the non-display.

Further, here, an example in which the display and the non-display of the icon G-3 are switched in accordance with the switching manipulation of the farmer K has been described. However, an icon to be displayed may be automatically selected by the display control unit 111. For example, a case in which an icon which the farmer K desires to see differ depending on the position of the farmer K or a behavior of the farmer K. In this regard, the display control unit 111 may control the display of the icon corresponding to the state of the cow in a case in which the state of the cow corresponds to the position of the farmer K or the behavior of the farmer K. The position information of the communication terminal 10-1 (the farmer K) may be obtained on the basis of the sensor data detected by the detecting unit 120 as described above. Further, behavior information of the farmer K may be obtained on the basis of the sensor data detected by the detecting unit 120 or on the basis of the sensor data detected by sensors installed in various facilities as will be described later.

Specifically, in a case in which the farmer K is in an office, the farmer K is unlikely to desire to see an icon particularly. In other words, no icon corresponds to the position “office” in which the farmer K is located. Therefore, the display control unit 111 may not display an icon in a case in which the farmer K is in the office.

On the other hand, in a case in which the farmer K is in a cowshed, if the cow in the estrus state is likely to be in the cowshed, the farmer K is considered to be likely to desire to see the icon G-2 corresponding to the state “estrus confirmation.” In other words, the icon G-2 corresponding to “estrus confirmation” can correspond to the position “cowshed” in which the farmer K is located. In this regard, the display control unit 111 may control the display of the icon G-2 corresponding to the state “estrus confirmation” in a case in which the farmer K is in the cowshed.

Further, in a case in which the farmer K is in the cowshed, if the cow in the estrus state is unlikely to be in the cowshed, the farmer K is considered to be likely to desire to see the icon G-3 corresponding to the state “periodic measurement.” In other words, the icon G-3 corresponding to “periodic measurement” can correspond to the position “cowshed” in which the farmer K is located. In this regard, the display control unit 111 may control the display of the icon G-3 corresponding to the state “periodic measurement” in a case in which the farmer K is in the cowshed.

Specifically, in a case in which feeding is performed, the farmer K is likely to see a different icon from that in a case in which milking is performed. In other words, the display control unit 111 may control display of an icon corresponding to a behavior “feeding” in a case in which the behavior of the farmer K is “feeding.” On the other hand, in a case in which the behavior of the farmer K is “milking,” the display control unit 111 may control display of an icon corresponding to a behavior “milking.” For example, in a case in which the farmer K is detected by a sensor installed in a feeding tractor, it can be determined that the behavior of the farmer K is “feeding.” Further, in a case in which the farmer K is detected by a proximity sensor installed in a place in which milking is performed, it can be determined that the behavior of the farmer K is “milking.”

Further, when there is a plurality of cow states, all icons corresponding to the plurality of states may be displayed, but only an icon of a predetermined state may be displayed. At this time, the icon of the predetermined state to be displayed may be selected on the basis of a priority. In other words, in a case in which there is a plurality of states for a cow, the display control unit 111 may selects a predetermined state from a plurality of states on the basis of the priority of each of the plurality of states and control display of an icon corresponding to each predetermined state. For example, the display control unit 111 may select a state whose priority is greater than a threshold value from a plurality of states and control display of an icon corresponding to the selected state. Although the priority of each state is not limited, the priority of the state “abnormality confirmation” may be highest, and the priority of the state “estrus confirmation” may be second highest, and the priority of the state “periodic measurement” may be lowest.

Further, when there is a plurality of cows, all icons corresponding to the states of the plurality of cows may be displayed, but only an icon of a predetermined state may be displayed. At this time, the icon of the predetermined state to be displayed may be selected on the basis of the priority. In other words, in a case in which there is a plurality of cows, the display control unit 111 may select a predetermined state from states of a plurality of cows on the basis of the priority of each of the states of the plurality of cows and control display of an icon corresponding to each predetermined state. For example, the display control unit 111 may select a state whose priority is greater than a threshold value from the state of each of a plurality of cows and control display of an icon corresponding to the selected state. In this case, it is desirable to display an icon only for a cow of a state satisfying a predetermined priority condition among the plurality of states. For example, as another embodiment, priority type information such as “preferential” or “non-preferential” may be set for each state, and an icon may be displayed only for a cow corresponding to a state whose priority information is “preferential.” At this time, the display control unit 111 may perform control such that a headcount of cows whose icon is not displayed is displayed for each state.

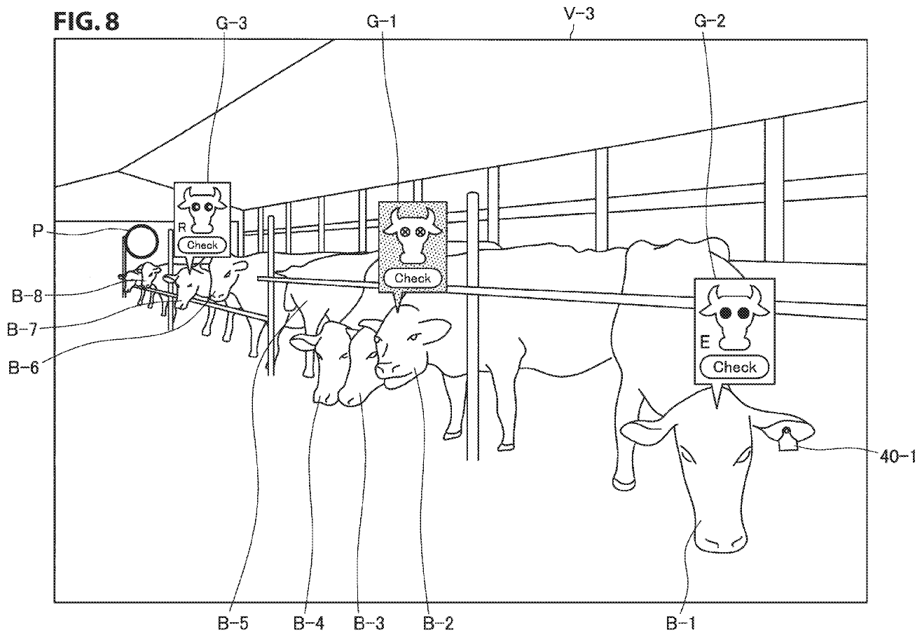

FIG. 8 is a diagram illustrating a second modified example of the display by the communication terminal 10-1 used by the farmer K. FIG. 6 illustrates the example in which all of the icon G-2 corresponding to the state “estrus confirmation,” the icon G-1 corresponding to the state “abnormality confirmation”, and the icon G-3 corresponding to the state “periodic measurement” are displayed with the same size regardless of a distance between the cow and the communication terminal 10-1. However, in order to make it easy to intuitively understand the perspective from the farmer K to the cow, it is desirable for the display control unit 111 to perform control such that the icons G-1 to G-3 are displayed with sizes corresponding to the distances between the cows and the farmer K (that is, the communication terminal 10-1).

Here, the size corresponding to the distance between the cow and the communication terminal 10-1 is a size corresponding to the distance between the icon virtually arranged in an AR space in accordance with the position of the cow and the communication terminal 10-1. Referring to FIG. 8, a field of view V-3 of the farmer K is illustrated. In the field of view V-3, the display control unit 111 performs control such that the icon G is displayed with a smaller size as it is farther from the communication terminal 10-1 (forms control such that the icon G-3, the icon G-1, and the icon G-2 are displayed in the ascending order of sizes).

In this case, the visibility of the icon arranged far from the communication terminal 10-1 is likely to deteriorate. In this regard, it is desirable for the display control unit 111 to control the display of the icon corresponding to the state in accordance with the display state corresponding to the priority of the state of the cow.

More specifically, the display control unit 111 may cause a display state of an icon corresponding to a state whose priority is higher than the reference priority (for example, the icon G-1 corresponding to the state “abnormality confirmation”) to differ from a display state of an icon corresponding to a state whose priority is lower than the reference priority (for example, the icon G-2 corresponding to the state “estrus confirmation,” the icon G-3 corresponding to the state “periodic measurement,” or the like) (a color may be changed as illustrated in FIG. 8). The display state can be made different through any method. For example, the display control unit 111 may cause an icon corresponding to a state whose priority is higher than the reference priority to be easily noticeable by addition of a motion (such as bouncing).

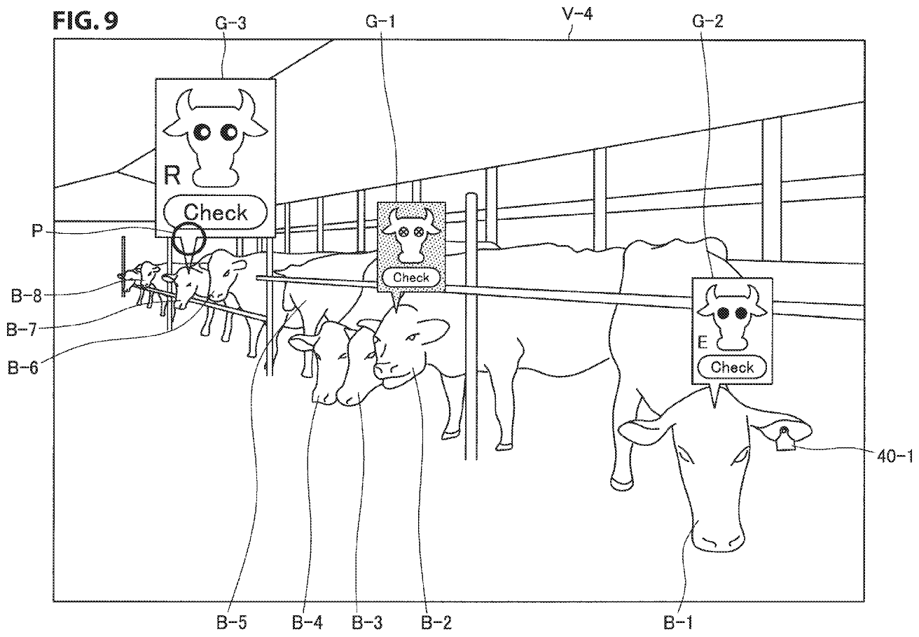

FIG. 9 is a diagram illustrating a third modified example of the display by communication terminal 10-1 used by the farmer K. Referring to FIG. 9, a field of view V-4 of the farmer K is illustrated. In the field of view V-4, a pointer P is at the position of the icon G-3. In this case, as illustrated in FIG. 9, the display control unit 111 may enlarge the icon G-3. Accordingly, the visibility of the icon G-3 is improved. As described above, it is desirable for the display control unit 111 to enlarge the icon G in a case in which the pointer P is at the position of the icon G or the position near the icon G.

The icon G displayed as described above may be selectable. The selection of the icon G may be performed by the selecting unit 112 in a case in which the selection manipulation by the farmer K is detected by the detecting unit 120 in the communication terminal 10-1. The variations of the selection manipulation have been described above.

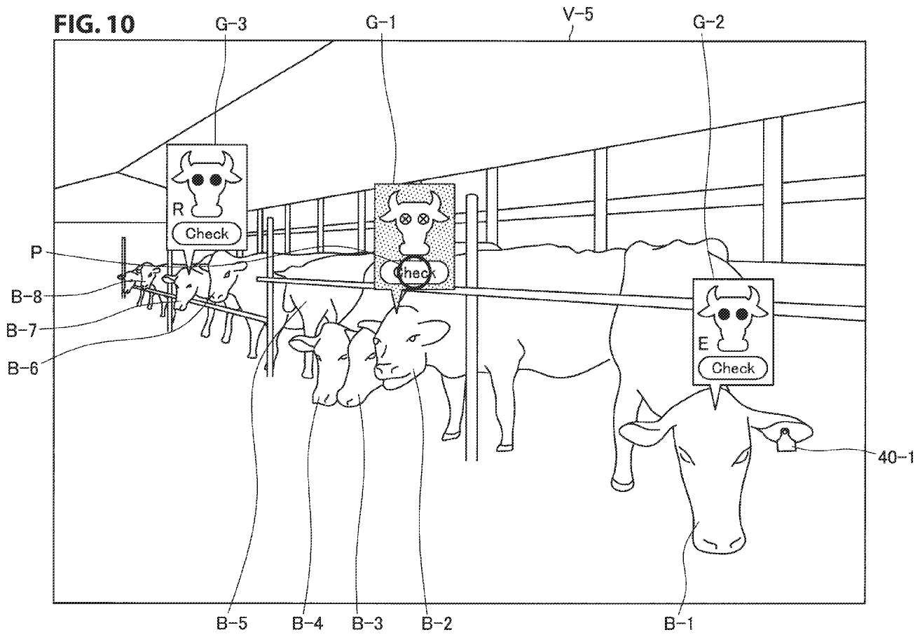

FIG. 10 is a diagram for describing a selection example of the icon G-1 corresponding to the state “abnormality confirmation.” Referring to FIG. 10, a field of view V-5 of the farmer K is illustrated. For example, a case in which the farmer K performs the selection manipulation by matching the indication direction (for example, the line of sight of the farmer K) with the icon G-1 corresponding to the state “abnormality confirmation” of the cow B-2 is assumed. In this case, in a case in which the selection manipulation is detected by the detecting unit 120, the selecting unit 112 determines that the icon G-1 is located in the indication direction of the farmer K detected by the detecting unit 120, and selects the icon G-1 corresponding to the state “abnormality confirmation.”

As described above, it is desirable for the display control unit 111 to perform control such that the pointer P is displayed at the position with which the indication direction of the farmer K (for example, the line of sight of the farmer K) matches. In other words, it is desirable for the selecting unit 112 to select the icon G in a case in which the selection manipulation is performed in the state in which the pointer P is at the position of the icon G or the position near the icon G. Further, as described above, control may be performed such that the pointer P is displayed at the position with which the direction of interest of farmer (for example, the direction of the face of the farmer K) matches instead of the indication direction of the farmer K.

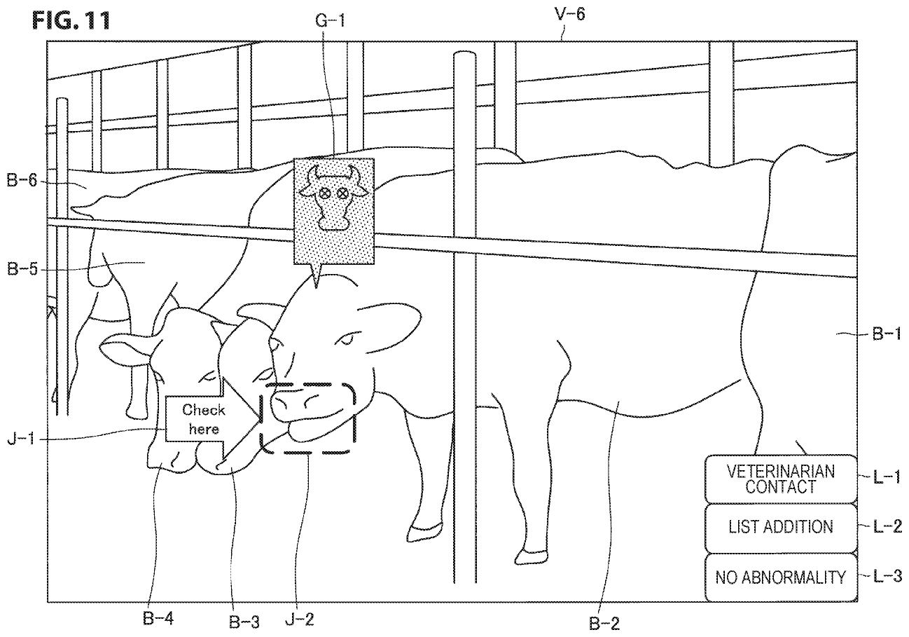

FIG. 11 is a diagram illustrating an example of the field of view of the farmer K after selecting the icon G-1 corresponding to the state “abnormality confirmation.” Referring to FIG. 11, since the farmer K approaches the cow B-2 corresponding to the state “abnormality confirmation,” the cow B-2 is closed up for the farmer K. In this case, in a case in which the icon G-1 is selected by the selecting unit 112, the display control unit 111 controls guidance display of guiding the farmer K to visually recognize a confirmation part corresponding to the state “abnormality confirmation” in the cow B-2.

According to such a configuration, if the farmer K selects an icon corresponding to the state in the cow, since guidance is given so that the farmer K visually recognizes the confirmation part corresponding to the state in the cow, it is possible to easily managing the cows. For example, in a case in which the farmer K desires to perform work only on a cow which is required to be confirmed, if the farmer K views only the cow whose icon is displayed, the farmer K can comprehend the confirmation part and perform necessary communication. At this time, the farmer K can specify the cow which is required to be confirmed and naturally move the line of sight from the icon to the confirmation part, and thus a manipulation burden on the farmer K can be reduced.

The confirmation part may be in the field of view of the farmer K or may not be in the field of view of the farmer K. For example, in a case in which the confirmation part is in the field of view of the farmer K, it is desirable for the display control unit 111 to control highlighting display for the confirmation part as the guidance display.

As an example, a case in which the confirmation part corresponding to the state “abnormality confirmation” in the cow B-2 is a nose is assumed. In this case, since the confirmation part “nose” is in a field of view V-6, it is desirable for the display control unit 111 to control the highlighting display (for example, the AR display) for the confirmation part “nose” as the guidance display of guiding the farmer K to visually recognize the confirmation part “nose.” Here, the highlighting display is not particularly limited. In the example illustrated in FIG. 11, the highlighting display is performed by an arrow J-1 pointing to the confirmation part “nose” and a broken line J-2 surrounding the confirmation part “nose.”

For example, in a case in which the confirmation part corresponding to the state “abnormality confirmation” in cow B-2 is a nose, the following cases are assumed. For example, a case in which, in the server 20, the information acquiring unit 211 estimates that the cow B-2 is suspected of having a cold as the state of the cow B-2 since the body temperature of the cow B-2 has increased to exceed a predetermined value for a predetermined period (for example, a short period such as two to three hours). Here, in a case in which the muzzle (the surface of the nose) of the cow B-2 is dry, and a definite fever symptom is confirmed, the cow B-2 is likely to have a cold. Further, in a case in which a runny nose symptom of the cow B-2 is confirmed, the cow B-2 is likely to have a cold.

Therefore, in a case in which it is estimated that the cow B-2 is suspected of having a cold in the server 20, it is desirable for the farmer K to confirm the state of the nose of the cow B-2. In this regard, in a case in which it is estimated that the cow B-2 is suspected of having a cold in the server 20, in the communication terminal 10-1, in a case in which the detecting unit 120 includes an image sensor, it is desirable for the display control unit 111 to recognize the nose of the cow B-2 from an image obtained by the image sensor and perform the highlighting display for the nose as the confirmation part.

The confirmation part corresponding to the state “abnormality confirmation” is not limited to the nose, and the confirmation part may differ depending on a type of abnormal state. For example, a case in which, in the server 20, the information acquiring unit 211 estimates that the cow B-2 is suspected of having an injury on the foot as the state of the cow B-2 since the activity amount of the cow B-2 has decreased to exceed a predetermined value for a predetermined period (for example, a short period). In this case, it is desirable for the farmer K to confirm the state of the foot of the cow B-2. In this regard, it is desirable for the display control unit 111 to recognize the foot of the cow B-2 from the image obtained by the image sensor and perform the highlighting display for the foot as the confirmation part.

Further, a case in which, in the server 20, the information acquiring unit 211 estimates that a state of faeces is required to be confirmed as the state of the cow B-2. In this case, it is desirable for the farmer K to confirm an anal state of the cow B-2. In this regard, the display control unit 111 may recognize the anus of the cow B-2 from an image obtained by the image sensor and perform the highlighting display for the anus as the confirmation part.

Further, a case in which, in the server 20, the information acquiring unit 211 estimates that the cow B-2 is suspected of having mastitis as the state of the cow B-2 on the basis of a measurement result of the milk components by an automatic milking machine (an example of the breeding machine 70) is assumed. In this case, it is desirable for the farmer K to confirm the breast of the cow B-2. In this regard, the display control unit 111 may recognize the breast of the cow B-2 from an image obtained by the image sensor and perform the highlighting display for the breast as the confirmation part.

As described above, in the embodiment of the present disclosure, the icon corresponding to the state of the cow is displayed in the vicinity of the cow (for example, above the head of the cow). Further, the confirmation part corresponding to the state of the cow corresponding to the selected icon among the displayed icons is highlighted and displayed by the AR display. Therefore, according to the embodiment of the present disclosure, there are effects in that it is possible to reduce the cognitive burden on the farmer K by reducing the movement of the line of sight of the farmer K in a case in which the farmer K confirms the confirmation part by looking at the highlighting display after selecting the icon. On the other hand, for example, a case in which a list of cows which are required to be checked is displayed on a smartphone, and a schematic diagram illustrating the confirmation part at a position distant from the list is displayed on the smartphone is assumed. In this case, at least one hand of the farmer K is tied up, and the movement of the line of sight of the farmer K increases as well. The work burden on the farmer K is not reduced.

Further, in the example illustrated above, the case in which there is one confirmation part corresponding to the state “abnormality confirmation” has mainly been described. However, there may be a plurality of confirmation parts corresponding to the state “abnormality confirmation.” Even in this case, the display control unit 111 may perform the highlighting display for each of the plurality of confirmation parts corresponding to the state “abnormality confirmation.”

In a case in which the confirmation part highlighted by the highlighting display is confirmed by the farmer K, and the detecting unit 120 detects that the confirmation of the confirmation part by the farmer K has been completed, the process control unit 114 may control execution of the process. Here, the process whose execution is controlled by the process control unit 114 is not particularly limited. For example, the process whose execution is controlled by the process control unit 114 may include at least one of a video call start process with other devices, a process of adding identification information of the cow B-2 corresponding to the state “abnormality confirmation” to an abnormality confirmation list, or a process of adding information indicating that there is no abnormality to the state “abnormality confirmation” of the cow B-2.

For example, the detection indicating that the confirmation of the confirmation part has been completed may be detection of the selection manipulation by the farmer K. For example, the display control unit 111 controls display of a veterinarian contact button L-1, a list addition button L-2, and a no abnormality button L-3. If the confirmation part indicated by the highlighting display is confirmed, the farmer K performs the selection manipulation on any one of the veterinarian contact button L-1, the list addition button L-2, and the no abnormality button L-3. If the selection manipulation by the farmer K is detected by the detecting unit 120, the process control unit 114 may select a process on the basis of the selection manipulation by the farmer K and control execution of the selected process. Further, in a case in which a confirmation result of the confirmation part by the farmer K is input, the communication unit 130 may transmit a confirmation result input data corresponding to the confirmation result to the server 20. The confirmation result input data transmitted by the communication unit 130 may be stored in the storage unit 220 in the server 20 in association with the identification information of the cow B-2.

In a case in which the selection manipulation by the farmer K on the veterinarian contact button L-1 is detected by the detecting unit 120, the process control unit 114 may initiate the video call with the communication terminal 10-2 used by the veterinarian M. A conversation is performed between the farmer K and the veterinarian M through the video call. According to this function, in a case in which the farmer K determines that the state of the cow B-2 is very bad, and an urgent treatment is required for the cow B-2, the farmer K can immediately make a call to the veterinarian M and call the veterinarian M to the place of the farmer K.

Further, the process control unit 114 may automatically activate the image sensor included in the detecting unit 120 during the video call and control the communication unit 130 so that an image (video) captured by the image sensor is transmitted to the communication terminal 10-2 used by the veterinarian M. Accordingly, since the farmer K can show the veterinarian M the confirmation part of the cow B-2 in real time, the veterinarian M can perform more accurate examination.

Further, in a case in which the selection manipulation by the farmer K on the veterinarian contact button L-1 is detected by the detecting unit 120, the process control unit 114 may control the communication unit 130 such that flag information indicating that the communication with the veterinarian has been performed to the server 20 as an example of the confirmation result input data. In the server 20, if the flag information indicating that the communication with the veterinarian has been performed is received by the communication unit 230, the storage unit 220 may store the flag information in association with the identification information of the cow B-2. Further, the process control unit 114 may control the communication unit 130 such that a voice and a video at the time of video call are transmitted to the server 20 together with a call history (such as a call start time). In the server 20, if the voice, the video, and the call history are received by the communication unit 230, the storage unit 220 may store the voice, the video, and the call history in association with the identification information of the cow B-2.

Further, in a case in which the communication with the veterinarian M ends, the process control unit 114 may control the communication unit 130 such that flag information indicating necessary diagnosis is transmitted to the server 20 as an example of the confirmation result input data. In the server 20, if the flag information indicating the necessary diagnosis is received by the communication unit 230, the storage unit 220 may store the flag information in association with identification information of the cow B-2. Accordingly, in the communication terminal 10-2 used by the veterinarian M, a mark indicating that the flag information indicating the necessary diagnosis is attached can be AR-displayed on the basis of the position of the cow B-2.

In a case in which the selection manipulation by the farmer K on the list addition button L-2 is detected by the detecting unit 120, the process control unit 114 may control the communication unit 130 such that the flag information indicating the necessary diagnosis is transmitted to the server 20 as an example of the confirmation result input data. Accordingly, even in a case in which an urgent treatment for the cow B-2 is unnecessary, the veterinarian M can examine the cow B-2 when visiting the farmer K later. Further, the flag information may be 0 (examination not required)/1 (examination required) or may be time information such as a current date (for example, year, month, and day, or the like).

In the server 20, in a case in which the flag information indicating the necessary diagnosis is received by the communication unit 230, the storage unit 220 may store the flag information indicating the necessary diagnosis in association with the identification information of the cow B-2. Accordingly, in the communication terminal 10-2 used by the veterinarian M, a mark indicating that the flag information indicating the necessary diagnosis is attached can be AR-displayed on the basis of the position of the cow B-2. The veterinarian M can perform clinical practice efficiently on the basis of the abnormality confirmation list (the identification information of the cow with the flag information indicating the necessary diagnosis) and the AR display when visiting the farmer K later.

Further, even in a case in which the selection manipulation by the farmer K on the veterinarian contact button L-1 is detected by the detecting unit 120, and the video call with the communication terminal 10-2 used by the veterinarian M is performed, diagnosis for the cow B-2 may be necessary. In this case, the farmer K may perform the selection manipulation on the list addition button L-2. The process performed in a case in which the selection manipulation by the farmer K on the list addition button L-2 is detected by the detecting unit 120 has been described above.

Further, the display control unit 111 may control display of an imaging start button (not illustrated) for starting capturing of a still image or a moving image with the image sensor included in the communication terminal 10-1 of the farmer K. Further, in a case in which the selection manipulation by the farmer K on the imaging start button (not illustrated) is detected by the detecting unit 120, the process control unit 114 may start the capturing of the still image or the moving image and control the communication unit 130 such that the still image or the moving image is transmitted to the server 20. In the server 20, if the still image or the moving image is received by the communication unit 230, the storage unit 220 may store the still image or the moving image in association with the identification information of the cow B-2.

Further, the manipulation for starting the capturing of the still image or the moving image with the image sensor included in the communication terminal 10-1 of the farmer K is not limited to the selection manipulation on the imaging start button (not illustrated). For example, the manipulation for starting the capturing of the still image or the moving image may be any other selection manipulation (for example, a gesture command, a voice command, or the like).

Further, when the identification information of the cow B-2 corresponding to the state “abnormality confirmation” is added to the abnormality confirmation list, the farmer K may be able to add additional information such as a disease name which the cow B-2 is suspected of having (for example, by voice or the like). At this time, the process control unit 114 may control the communication unit 130 such that the additional information detected by the detecting unit 120 is transmitted to the server 20. In the server 20, if the additional information is received by the communication unit 230, the storage unit 220 may store the additional information in association with the identification information of the cow B-2.

In a case in which the selection manipulation by the farmer K on the no abnormality button L-3 is detected by the detecting unit 120, the process control unit 114 may control the communication unit 130 such that flag information indicating that there is no abnormality to the server 20 as an example of the confirmation result input data. In the server 20, in a case in which the flag information indicating that there is no abnormality is received by the communication unit 230, the storage unit 220 may store the flag information in association with the identification information of the cow B-2.

In this case, in a case in which the state of the cow B-2 is estimated to be “abnormality confirmation” by the server 20, but there is no abnormal part in an observation of the farmer K (for example, in a case in which erroneous estimation is made by the server 20), the display control unit 111 performs a display control process so that the display of the icon G-1 indicating the state “abnormality confirmation” is restricted until the state “abnormality confirmation” is newly estimated by the server 20.

The example in which the process control unit 114 selects any one of the processes “contact veterinarian,” “add to list,” and “no abnormality” on the basis of the selection manipulation by the farmer K has been described above. However, the process control unit 114 can also select a process on the basis of the sensor data. The sensor data may be detected by the external sensor 30, may be detected by the wearable device 40, or may be detected by the detecting unit 120 in the communication terminal 10-1 used by the farmer K.

For example, the sensor data may be an image captured by the image sensor of the detecting unit 120 in the communication terminal 10-1. At this time, the process control unit 114 may recognize a portion highlight-displayed from an image and automatically select any one of the processes “contact veterinarian,” “add to list,” and “no abnormality” on the basis of an image recognition result.

Further, the result of selecting any one of the processes “contact veterinarian,” “add to list,” and “no abnormality” by the farmer K on the basis of the guidance display may be used as correct data of a machine learning process for the state estimation on the basis of the sensor data as the confirmation result input data. As described above, an example of the confirmation result input data includes the flag information (for example, the flag information indicating that the communication with the veterinarian has been performed, the flag information indicating the necessary diagnosis, the flag information indicating that there is no abnormality, and the like). Further, the machine learning process may be executed by the processing unit (machine learning control unit) 212 in the server 20. Specifically, the confirmation result input data by the farmer K is transmitted to the server 20 by the communication unit 130 and received by the communication unit 230 in the server 20. The processing unit (machine learning control unit) 212 in the server 20 performs the machine learning process of estimating the state of the cow on the basis of the sensor data for the cows. At this time, the confirmation result input data received by the communication unit 230 is used as the correct data of the machine learning process by the processing unit (machine learning control unit) 212. At this time, the confirmation result input data obtained in the communication terminal 10-1 in the past may also be used as the correct data of the machine learning process.

As described above, the confirmation result input data input after the farmer K looks at the location is used as the correct data of the machine learning process of performing the estimation on the basis of the sensor data and contributes to the improvement in the accuracy of the machine learning process. Depending on conditions such as individual differences between bred cows, feedstuff given to the cows, how to grow the cows, or climates of a place in which the farmer is located, a correct rate of the state estimation is likely to decrease. However, since the confirmation result input data is used as the correct data of the machine learning process, it is possible to perform the state estimation suitable for the farmer.

As described above, according to the embodiment of the present disclosure, the display control unit 111 can control the icon display only in the vicinity of the cow which is required to be checked and control the highlighting display of the confirmation part of the cow in a case in which the icon selection is detected by the detecting unit 120. Accordingly, the farmer K can take, for example, an action of contacting the veterinarian immediately once the confirmation part is confirmed. Therefore, it is possible to improve the efficiency of the confirmation work by the farmer K and reduce the burden on the farmer K. As comparative examples of the embodiment of the present disclosure, (1) a technique of displaying an icon indicating a state for all the cows from the beginning, (2) a technique of displaying an icon at a position corresponding to an abnormal state of a cow from the beginning, and the like are assumed, but according to the embodiment of the present disclosure, it is possible to perform display which is easier to see than in these techniques.

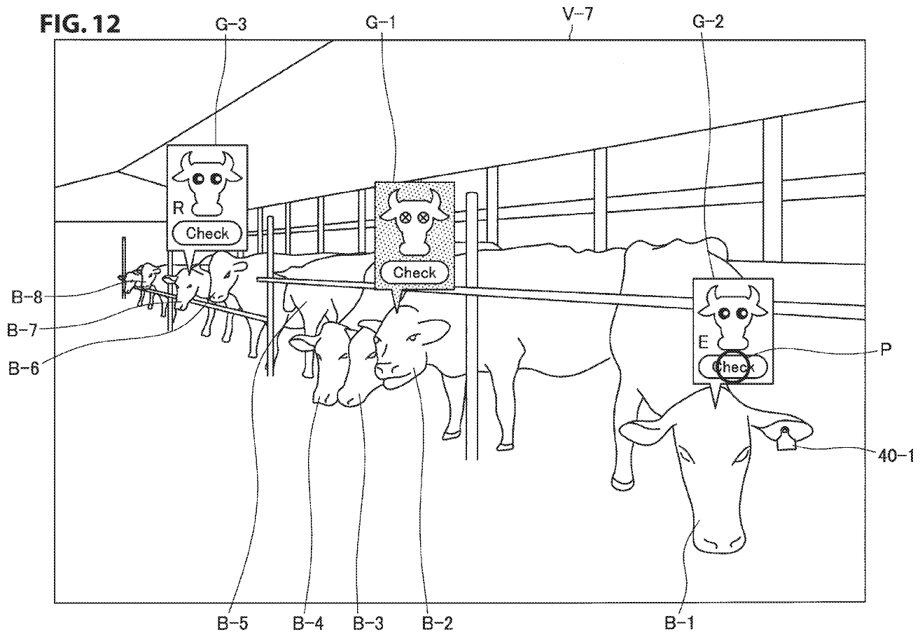

FIG. 12 is a diagram for describing a selection example of the icon G-2 corresponding to the state “estrus confirmation.” Referring to FIG. 12, a field of view V-7 of the farmer K is illustrated. The selecting unit 112 can select the icon G-2 corresponding to the state “estrus confirmation,” similarly to the selection of the icon G-1 corresponding to the state “abnormality confirmation.” Referring to the field of view V-7 of the farmer K, a pointer P matches with the icon G-2 corresponding to state “estrus confirmation.”

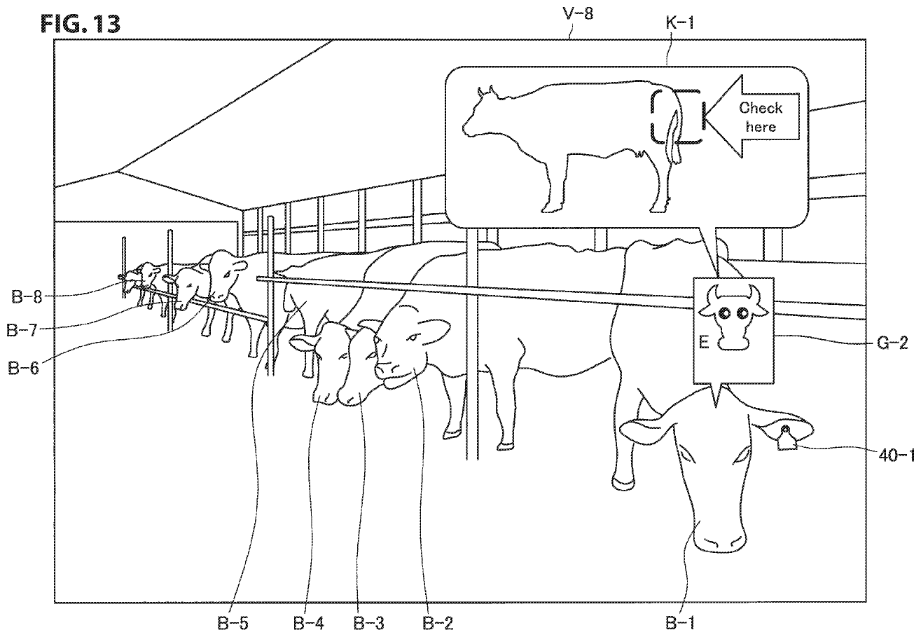

FIG. 13 is a diagram illustrating an example of the field of view of the farmer K after selecting the icon G-2 corresponding to the state “estrus confirmation.” Referring to FIG. 13, a field of view V-8 of the farmer K is illustrated. The display control unit 111 controls guidance display of guiding the farmer K to confirm the confirmation part corresponding to the state “estrus confirmation” in the cow B-2 in a case in which the selecting unit 112 selects the icon G-2. Here, the display control unit 111 may control auxiliary guidance display of urging the farmer K to move to a position at which the confirmation part is visible since it is difficult to recognize the confirmation part in a case in which there is no confirmation part in the field of view. For example, in a case in which there is no confirmation part in the field of view, it is desirable for the display control unit 111 to control the display of the still image or the moving image associated with the state “estrus confirmation.”

As an example, a case in which the confirmation part corresponding to the state “estrus confirmation” in the cow B-1 is the vulva is assumed. In this case, since the confirmation part “vulva” is not in the field of view V-7, it is desirable for the display control unit 111 to control the display (AR display) of the still image or the moving image as the guidance display of guiding the farmer K to visually recognize the confirmation part “vulva.” Here, a type of still image or moving image is not limited. In the example illustrated in FIG. 12, a schematic diagram K-1 is used as an example of the still image or the moving image.

For example, in a case in which the confirmation part corresponding to the state “estrus confirmation” in the cow B-1 is the vulva, the following cases are assumed. A case in which in the server 20, the information acquiring unit 211 estimates that the cow B-1 is suspected of being estrus as the state of the cow B-1 is assumed. Here, in a case in which estrus mucus (clear watery mucus) flows out from the vulva of the cow B-1, the cow B-1 is likely to be in the estrus. Therefore, in a case in which it is estimated that the cow B-1 is suspicious of being estrus in the server 20, it is desirable for the farmer K to first confirm the state of the vulva of the cow B-1.

In this regard, in a case in which it is assumed that cow B-1 is suspicious of being estrus in the server 20, in the communication terminal 10-1, it is desirable for the display control unit 111 to control the AR display of the schematic diagram K for giving guidance so that the vulva of the cow is visually recognized. In the example illustrated in FIG. 13, a picture of the body of the cow and an arrow pointing to a part having the vulva in the body of the cow are illustrated in the schematic diagram K-1. However, the schematic diagram K-1 is not limited to this example. Further, in the example illustrated in FIG. 13, the schematic diagram K-1 is AR-displayed to extend from the icon G-2, but it is desirable that the schematic diagram K-1 be displayed on the basis of the position of the cow B-1.

In a case in which the farmer K looks at the schematic diagram K-1, the farmer K moves to a position at which the vulva of the cow B-1 can be visually recognized in accordance with the schematic diagram K-1.

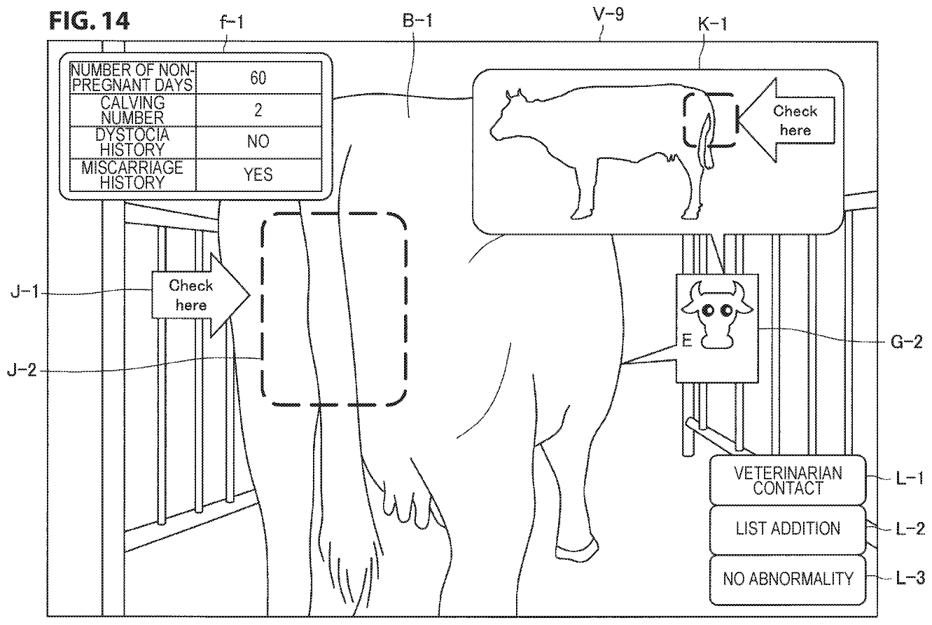

FIG. 14 is a diagram illustrating an example of the field of view of the farmer K including the vulva of the cow B-1 corresponding to the state “estrus confirmation.” As illustrated in FIG. 14, in a case in which the vulva of the cow B-1 is in a field of view V-9 of the farmer K, in the communication terminal 10-1, the display control unit 111 recognizes the vulva from an image obtained by the image sensor of the detecting unit 120 and performs the highlighting display for the vulva as the confirmation part.

In the example illustrated in FIG. 14, similarly to the highlighting display for the confirmation part “nose,” the highlighting display is performed by an arrow J-1 pointing to the confirmation part “vulva” and a broken line J-2 surrounding the confirmation part “vulva.” Further, the display control unit 111 may generate information f-1 related to birthing on the basis of the individual information of the cow B-1 corresponding to the state “estrus confirmation” received from the server 20 by the communication unit 130 and control display of the information f-1 related to birthing. In the example illustrated in FIG. 14, the information f-1 related to birthing includes the number of non-pregnant days, a calving number, a dystocia history, and a miscarriage history, but the information f-1 related to birthing is not limited thereto.

Further, similarly to the case in which the highlighting display for the confirmation part “nose” corresponding to the state “abnormality confirmation” is performed, the display control unit 111 controls display of the veterinarian contact button L-1, the list addition button L-2, and the no abnormality button L-3.

The actions taken in a case in which the selection manipulation on each of the veterinarian contact button L-1, the list addition button L-2, and the no abnormality button L-3 is performed by the farmer K is substantially similar to that in a case in which the highlighting display for the confirmation part “nose” corresponding to the state “abnormality confirmation” is performed. However, in a case in which the selection manipulation on the veterinarian contact button L-1 is performed, the farmer K requests the veterinarian M to do artificial insemination through the video call.

Further, in a case in which the selection manipulation by the farmer K on the list addition button L-2 is detected by the detecting unit 120, the process control unit 114 may control the communication unit 130 such that flag information indicating the necessity of the artificial insemination is transmitted to the server 20. Accordingly, even in a case in which the urgent artificial insemination for the cow B-1 is unnecessary, it is possible to have the veterinarian M to perform the artificial insemination later.

In the server 20, in a case in which the flag information indicating the necessity of the artificial insemination is received by the communication unit 230, the storage unit 220 may store the flag information indicating the necessity of the artificial insemination in association with the identification information of the cow B-1. Accordingly, in the communication terminal 10-2 used by the veterinarian M, a mark indicating that the flag information indicating the necessity of the artificial insemination is attached can be AR-displayed on the basis of the position of the cow B-1. The veterinarian M can perform the artificial insemination efficiently on the basis of an artificial insemination list (the identification information of the cow with the flag information indicating the necessity of the artificial insemination) and the AR display.

Further, in the example illustrated in FIG. 12, the schematic diagram K-1 is used as the guidance display of guiding the farmer K to visually recognize the confirmation part “vulva.” However, a moving image may be used as the guidance display of guiding the farmer K to visually recognize the confirmation part “vulva.” For example, in a case in which a moving image estimated to be showing a mounting behavior of the cow B-1 is captured by the external sensor 30, the display control unit 111 may control the display of the moving image instead of the schematic diagram K-1. The farmer K can perform the estrus confirmation of the cow B-1 by confirming the moving image.

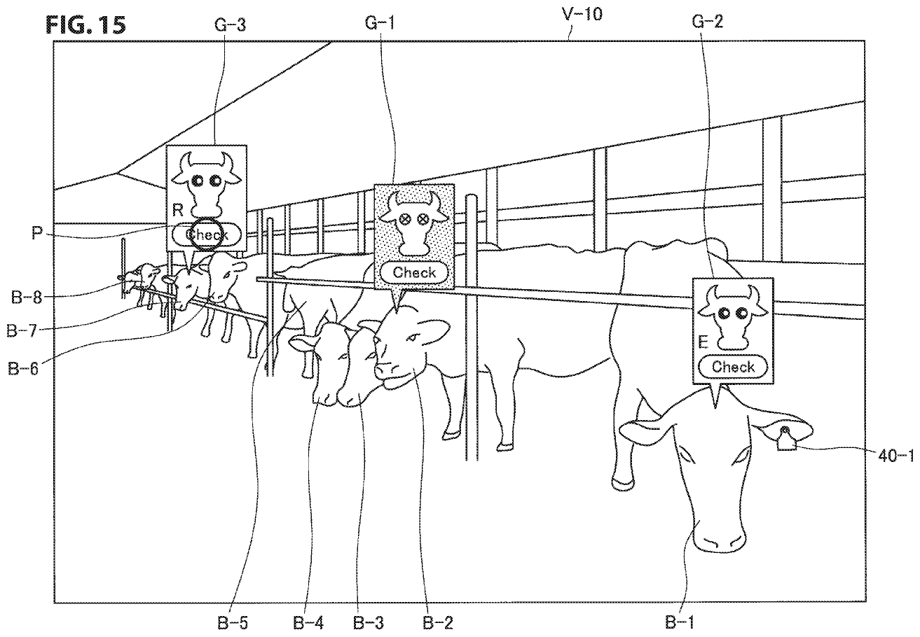

FIG. 15 is a diagram for describing a selection example of the icon G-3 corresponding to the state “periodic measurement.” Referring to FIG. 15, a field of view V-10 of the farmer K is illustrated. The selecting unit 112 can select the icon G-3 corresponding to the state “periodic measurement,” similarly to the selection of the icon G-1 corresponding to the state “abnormality confirmation.” Referring to the field of view V-10 of the farmer K, a pointer P matches with the icon G-3 corresponding to the state “periodic measurement.”

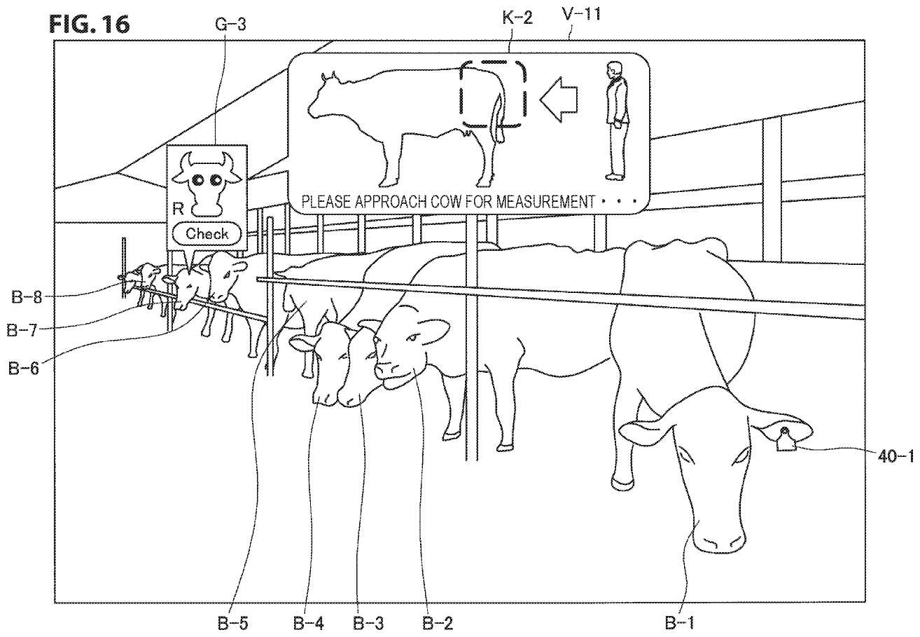

FIG. 16 is a diagram illustrating an example of the field of view of the farmer K after selecting the icon G-3 corresponding to the state “periodic measurement.” Referring to FIG. 16, a field of view V-11 of the farmer K is illustrated. In a case in which the selecting unit 112 selects the icon G-3, the display control unit 111 controls the guidance display of guiding the farmer K to visually recognize the confirmation part corresponding to the state “periodic measurement” in the cow B-7.

Here, as illustrated in FIG. 16, in a case in which a distance between the cow B-7 and the communication terminal 10-1 (the farmer K) is larger than a predetermined distance, since it is difficult to recognize the confirmation part, it is desirable for the display control unit 111 to control the display (AR display) of the still image or the moving image associated with the state “periodic measurement.” As described above, the distance between the cow B-7 and the farmer K may be calculated in the server 20 or may be calculated by the communication terminal 10-1.

Here, a type of still image or moving image is not limited. In the example illustrated in FIG. 16, a schematic diagram K-2 is used as an example of the still image or the moving image. In the example illustrated in FIG. 16, the schematic diagram K-2 includes a picture of the body of the cow, an arrow pointing to a part in which the BCS can be measured in the body of the cow, and a guidance (for example, text data) for encouraging an approach to the cow (with a positional relation for measurement). However, the schematic diagram K-2 is not limited thereto. Further, in the example illustrated in FIG. 16, the schematic diagram K-2 is AR-displayed to extend from the icon G-3, but it is desirable that the schematic diagram K-2 be displayed on the basis of the position of the cow B-7.

In a case in which the farmer K looks at the schematic diagram K-2, the farmer K moves to a position at which the BCS of the cow B-7 can be measured in accordance with the schematic diagram K-2.

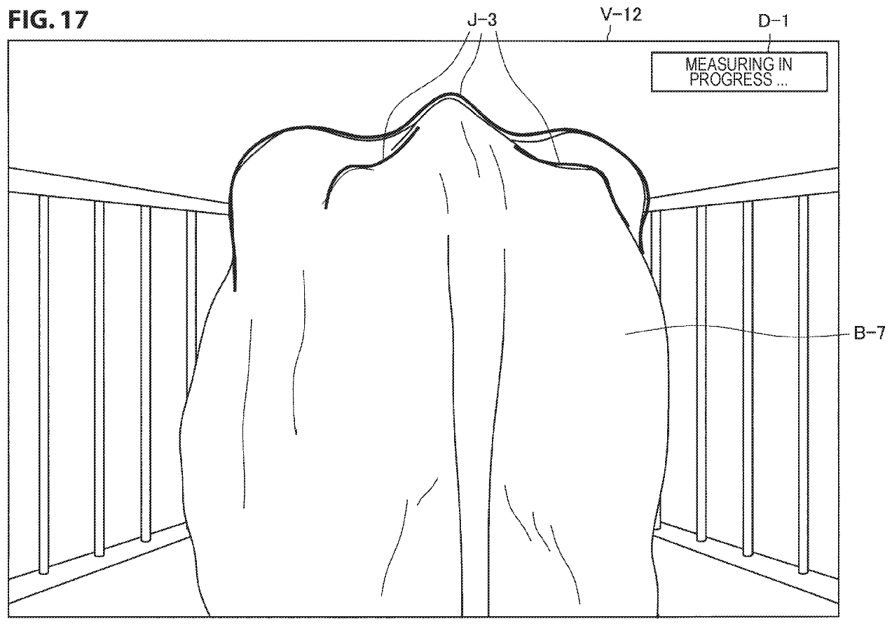

FIG. 17 is a diagram illustrating an example of the field of view of the farmer K including a part in which the BCS of the cow B-7 corresponding to state “periodic measurement” can be measured. As illustrated in FIG. 17, in a case in which a part in which the BCS of the cow B-7 can be measured is in a field of view V-12 of the farmer K, in the communication terminal 10-1, the display control unit 111 recognizes the part in which the BCS of the cow B-7 can be measured from an image obtained by the image sensor included in the detecting unit 120 and performs the highlighting display for the part in which the BCS can be measured as the confirmation part. In the example illustrated in FIG. 17, the highlighting display is performed for the confirmation part “BCS-measurable part” by a line J-3.

In a case in which the image obtained by the image sensor included the detecting unit 120 is obtained, the display control unit 111 can measure the BCS from the image. At this time, as illustrated in FIG. 17, the display control unit 111 can control display of a guidance D-1 indicating that the BCS is being measured. In the example illustrated in FIG. 17, the guidance D-1 indicating that the BCS is being measured is text data, but the guidance D-1 indicating that the BCS is being measured is not limited to the text data.

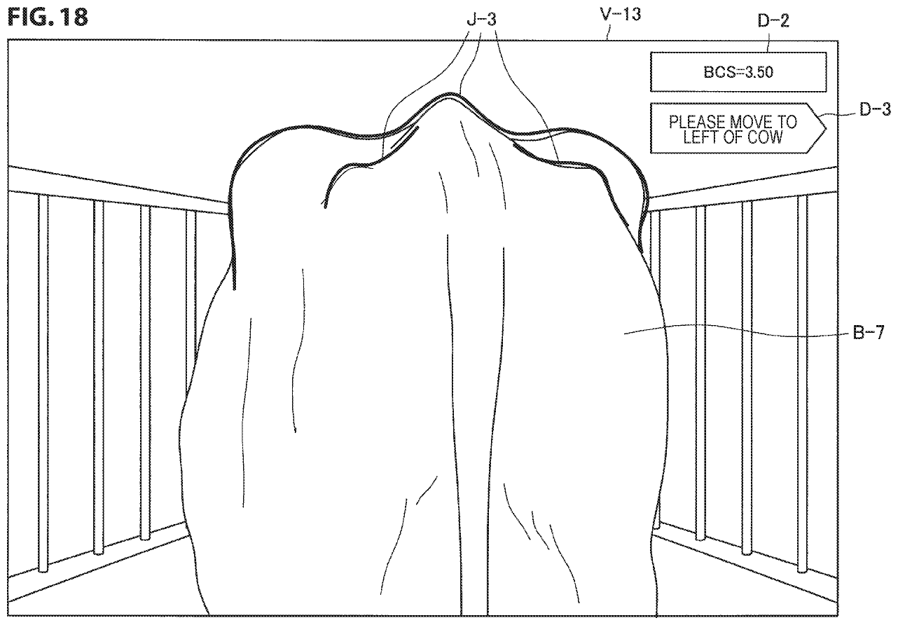

FIG. 18 is a diagram illustrating a display example of a first BCS measurement result. Referring to FIG. 18, a field of view V-13 of the farmer K is illustrated. In a case in which a first measurement of the BCS of the cow B-7 corresponding to the state “periodic measurement” is completed, the display control unit 111 causes a first BCS measurement result to be displayed as a BCS measurement result D-2 as illustrated in FIG. 18. Further, since the BCS measurement result of the first BCS measurement result is merely obtained on the basis of an image taken in one direction, it is assumed that a measurement accuracy of the first BCS measurement result is not so high. In this regard, as illustrated in FIG. 18, it is desirable for the display control unit 111 to control display of guidance D-3 of encouraging movement.

In the example illustrated in FIG. 18, the guidance D-3 for encouraging movement is text data, but the guidance D-3 for encouraging movement is not limited to text data. Further, in the example illustrated in FIG. 18, movement to the left is encouraged by the guidance D-3 of encouraging the movement, but a direction of movement encouraged by the guidance D-3 of encouraging the movement is not consequential. Further, for example, in a case in which the farmer K desires to measure the BCS in a short time, it is desirable to perform simple measurement. Therefore, in this case, the farmer K may end the measurement of the BCS without moving.

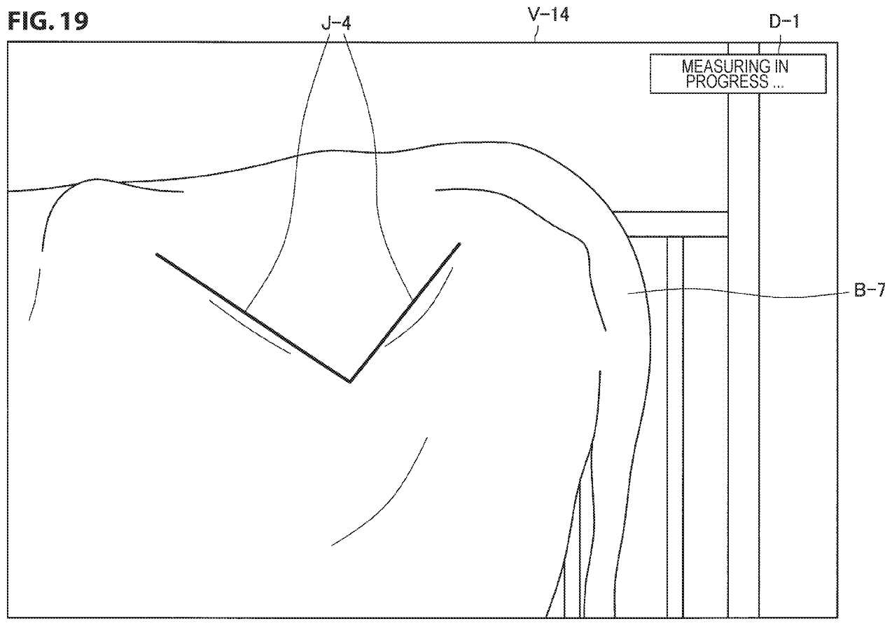

FIG. 19 is a diagram illustrating an example of the field of view of the farmer K including another part in which the BCS of the cow B-7 corresponding to state “periodic measurement” can be measured. As illustrated in FIG. 19, in a case in which another part in which the BCS of the cow B-7 can be measured is in a field of view V-14 of the farmer K, in the communication terminal 10-1, the display control unit 111 recognizes the other part in which the BCS of the cow B-7 can be measured from an image obtained by the image sensor included in the detecting unit 120 and performs the highlighting display for the other part in which the BCS can be measured as the confirmation part. In the example illustrated in FIG. 19, the highlighting display is performed for the confirmation part “another BCS-measurable part” by a line J-4.

In a case in which an image obtained by the image sensor included in the detecting unit 120 is obtained, the display control unit 111 can measure a second BCS on the basis of the image and the initially measured BCS. At this time, as illustrated in FIG. 19, the display control unit 111 can control the display of the guidance D-1 indicating that the BCS is being measured. It is assumed that the second BCS measured at this time is more accurate than the initially measured BCS.

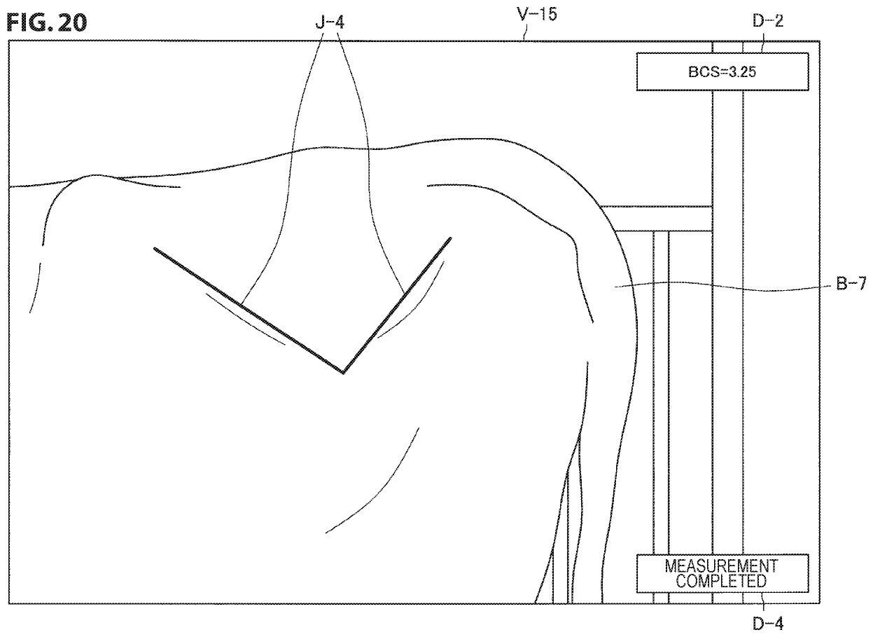

FIG. 20 is a diagram illustrating a display example of a second BCS measurement result. Referring to FIG. 20, a field of view V-15 of the farmer K is illustrated. In a case in which the second measurement of the BCS of the cow B-7 corresponding to the state “periodic measurement” is completed, the display control unit 111 may cause a second BCS measurement result to be displayed as the BCS measurement result D-2. Further, as illustrated in FIG. 20, it is desirable for the display control unit 111 to control display of a guidance D-4 indicating measurement completion. In the example illustrated in FIG. 20, the guidance D-4 indicating the measurement completion is text data, but the guidance D-4 indicating the measurement completion is not limited to the text data.

In the communication terminal 10-1, in a case in which the measurement of the BCS is completed, the identification information of the cow B-7, the BCS measurement result, and a measurement date are transmitted to the server 20 by the communication unit 130. In the server 20, in a case in which the identification information of the cow B-7, the BCS measurement result, and the measurement date are received by the communication unit 230, the storage unit 250 stores the BCS measurement result and the measurement date in the cow information (database) in association with the identification information of the cow B-7.

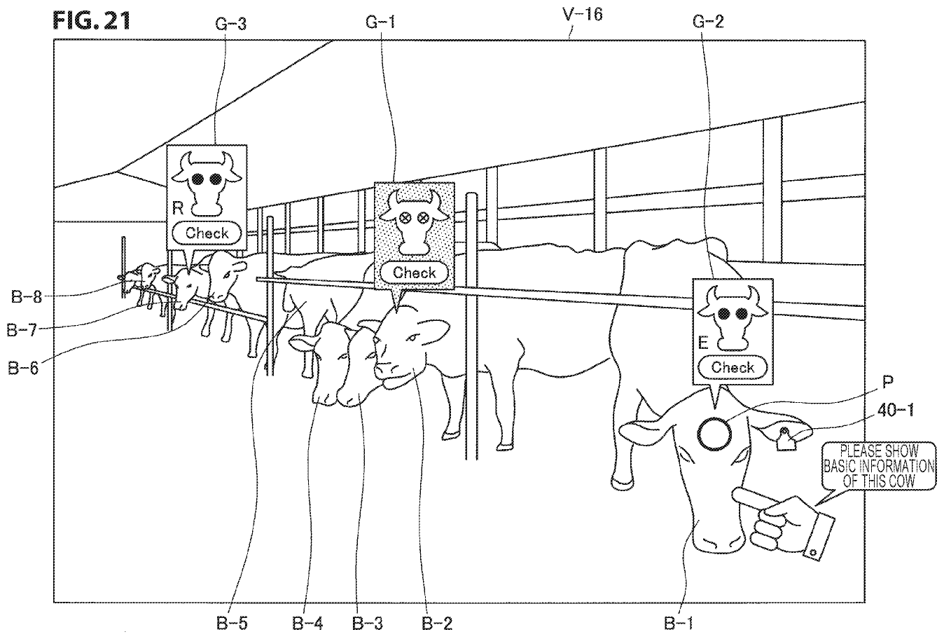

FIG. 21 is a diagram illustrating an example of a designation manipulation for displaying the basic information of the cow B-1. Referring to FIG. 21, a field of view V-16 of the farmer K is illustrated. Here, in a case in which the farmer K is considered to desire to confirm the basic information of the cow B-1, it is desirable for the farmer K to perform a predetermined designation manipulation on the cow B-1. The designation manipulation is not limited. In FIG. 21, as an example of the designation manipulation on the cow B-1, an action of matching the indication direction (for example, the line of sight) with the body of the cow B-1 and the selection manipulation (for example, the speech content of the farmer K “show basic information of this cow” or the like) are illustrated, but the designation manipulation on the cow B-1 is not particularly limited. Further, as illustrated in FIG. 21, it is desirable for the display control unit 111 to display the pointer P at a position with which the indication direction matches.

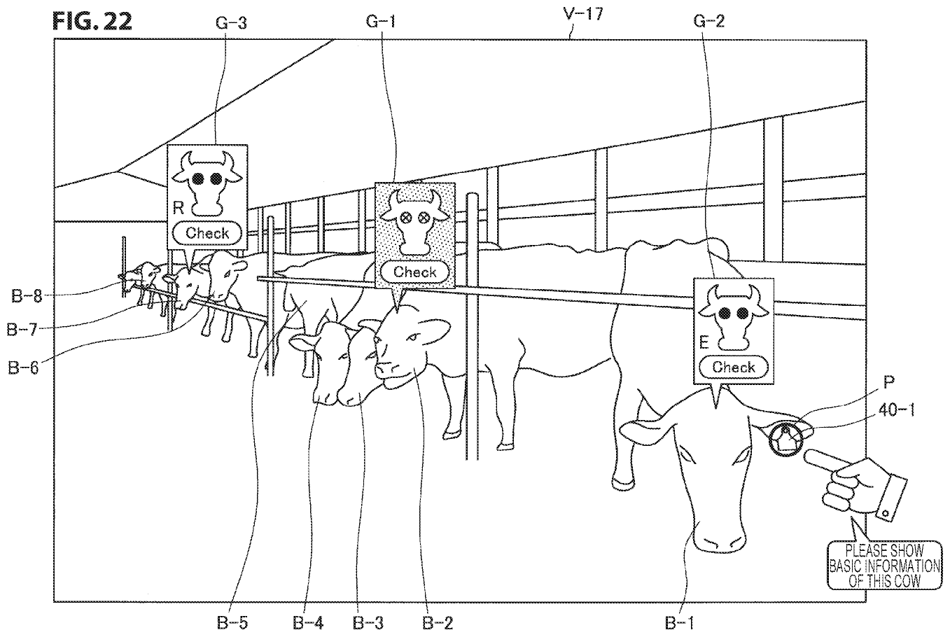

FIG. 22 is a diagram illustrating another example of the designation manipulation for displaying the basic information of the cow B-1. Referring to FIG. 22, a field of view V-17 of the farmer K is illustrated. In FIG. 22, as an example of the designation manipulation on the cow B-1, an action of matching the indication direction (for example, the line of sight) with the wearable device 40-1 attached to the cow B-1 and the selection manipulation (for example, the speech content of the farmer K “show basic information of this cow” or the like) are illustrated.

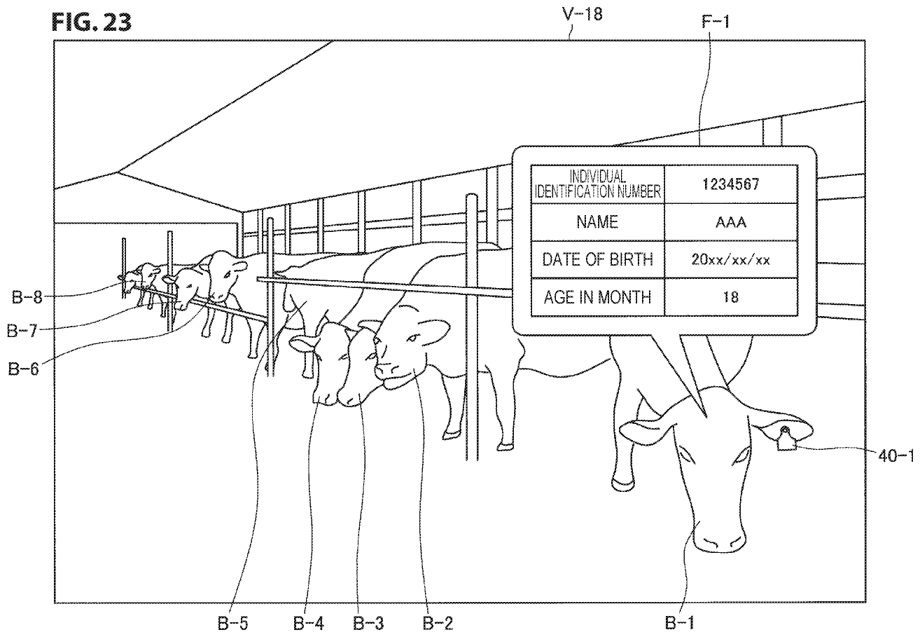

FIG. 23 is a diagram illustrating a display example of the basic information of the cow B-1. As described with reference to FIGS. 21 and 22, in a case in which the designation manipulation for designating the cow B-1 is performed by the farmer K, and the designation manipulation for designating the cow B-1 is detected by detecting unit 120, the display control unit 111 may extract basic information F-1 of the cow B-1 as an example of the information related to the cow B-1 from the individual information acquired from the server 20 and control display of the basic information F-1 of the cow B-1. In the example illustrated in FIG. 23, the basic information F-1 is AR-displayed to extend from the head of the cow B-1, but it is desirable that the basic information F-1 be displayed on the basis of the position of the cow B-1.

As described above, in a case in which the designation manipulation on the cow B-1 whose icon is displayed is detected, the display control unit 111 can control display of information not depending on the state of the cow B-1 (for example, the basic information). Further, in a case in which the designation manipulation on the cow B-3 whose icon is not displayed is detected, the display control unit 111 can control display of information of the cow B-3 (any one of information not depending on the state and information depending on the state of the cow B-3).

Accordingly, the farmer K can confirm the information not depending on the state of the cow B-1 whose icon is displayed and the information of the cow B-3 whose icon is not displayed in accordance with the designation manipulation if necessary.

The functions of communication terminal 10-1 used by the farmer K has mainly been described above.

### (1.6.2. Communication Terminal Used by Veterinarian)

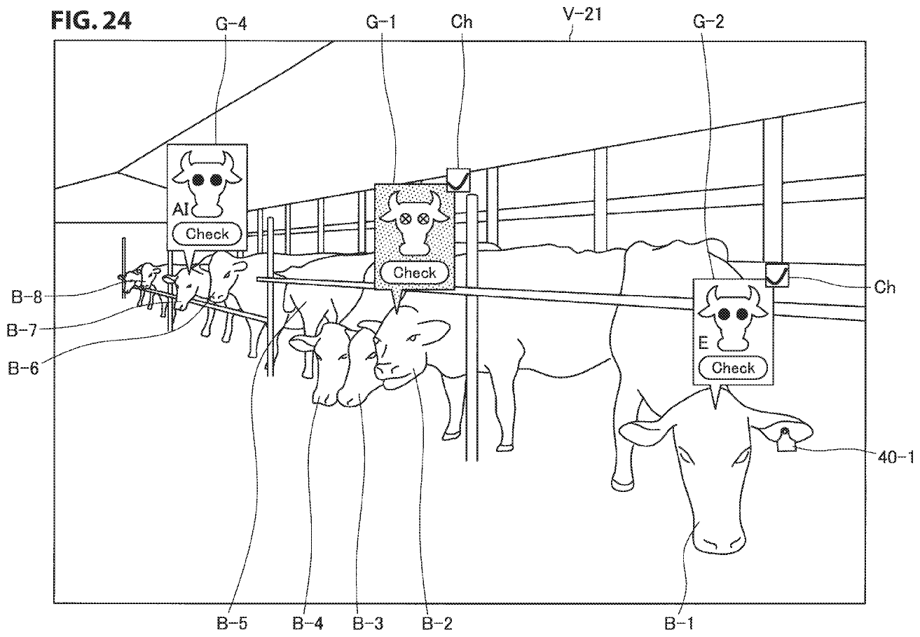

Next, the functions of communication terminal 10-2 used by the veterinarian M will be mainly described. FIG. 24 is a diagram illustrating an example of display by the communication terminal 10-2 used by the veterinarian M. In the example illustrated in FIG. 24, a case in which the veterinarian M wearing the communication terminal 10-2 is in the real world is assumed. More specifically, a case in which the veterinarian M is called by the farmer K through the video call or visits the farmer K periodically is assumed. Referring to FIG. 24, a field of view V-21 of the veterinarian M is illustrated.

Even in the communication terminal 10-2 used by the veterinarian M, similarly to the example described in the functions of the communication terminal 10-1 used by the farmer K, the display of the icon G-1 corresponding to the state “abnormality confirmation” in the cow B-2 and the icon G-2 corresponding to the state “estrus confirmation” in the cow B-1 may be controlled.

Further, in the communication terminal 10-2, the display control unit 111 determines that the identification information of the cow B-2 corresponding to the state “abnormality confirmation” is included in the abnormality confirmation list received from the server 20 by the communication unit 130. Therefore, the display control unit 111 controls AR display of a mark Ch indicating that the flag information indicating the necessary diagnosis is attached on the basis of the position of the cow B-2. In the example illustrated in FIG. 24, the mark Ch is AR-displayed to be attached to the icon G-1, but it is desirable that the mark Ch be displayed on the basis of the position of the cow B-2. A shape of the mark Ch is not particularly limited.

Further, in the communication terminal 10-2, the display control unit 111 determines that the identification information of the cow B-1 corresponding to the state “estrus confirmation” is included in the artificial insemination list received from the server 20 by the communication unit 130. Therefore, the display control unit 111 controls AR display of a mark Ch indicating that the flag information indicating the necessary of the artificial insemination is attached on the basis of the position of the cow B-1. In the example illustrated in FIG. 24, the mark Ch is AR-displayed to be attached to the icon G-2, but it is desirable that the mark Ch be displayed on the basis of the position of the cow B-1. A shape of the mark Ch is not particularly limited.

Further, a case in which, in the cow information stored in the server 20, the state of the cow B-7 is “pregnant” is assumed. In this case, in a case in which the state “pregnant” of the cow B-7 is received by the communication unit 130 in the communication terminal 10-2, the display control unit 111 controls display of an icon G-4 corresponding to the state “pregnant.” At this time, as illustrated in FIG. 24, the display control unit 111 may perform control such that the icon G-4 corresponding to the state “pregnant” is AR-displayed above the head of the cow B-7.

The icon G displayed as described above may be selectable. The selection of the icon G may be performed by the selecting unit 112 in a case in which the selection manipulation by the veterinarian M is detected by detecting unit 120 in communication terminal 10-2. The variations of the selection manipulation have been described above. Here, a case in which, similarly to the selection of the icon G-1 corresponding to the state “abnormality confirmation” by the communication terminal 10-1, the communication terminal 10-2 selects the icon G-1 corresponding to the state “abnormality confirmation” is assumed.

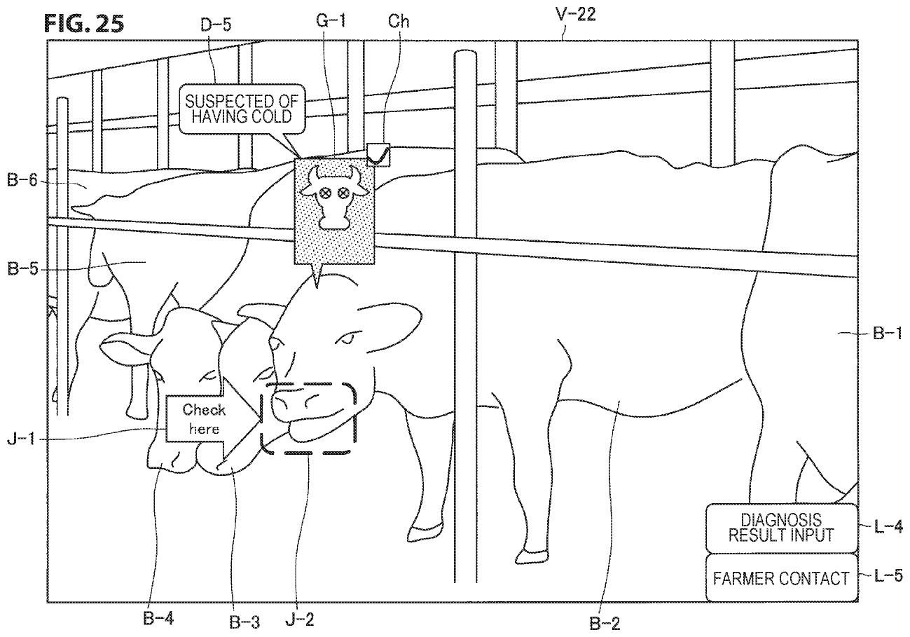

FIG. 25 is a diagram illustrating an example of the field of view of the veterinarian M after selecting the icon G-1 corresponding to the state “abnormality confirmation.” Referring to FIG. 25, as the veterinarian M approaches the cow B-2 corresponding to the state “abnormality confirmation,” the cow B-2 is closed up for the veterinarian M. Here, in the communication terminal 10-2, in a case in which the selecting unit 112 selects the icon G-1, the display control unit 111 control the guidance display of guiding the veterinarian M to visually recognize the confirmation part corresponding to the state “abnormality confirmation” in the cow B-2.

Here, in the communication terminal 10-2 used by the veterinarian M, similarly to the communication terminal 10-1 used by the farmer K, the display control unit 111 controls the highlighting display (for example, the AR display) for the confirmation part “nose” as the guidance display of guiding the veterinarian M to visually recognize the confirmation part “nose.” In the example illustrated in FIG. 25, the highlighting display is also performed by an arrow J-1 pointing to the confirmation part “nose” and a broken line J-2 surrounding the confirmation part “nose.”

Further, in the server 20, additional information D-5 input by voice input of the farmer K or the like is stored in the storage unit 220 in association with the identification information of the cow B-2. In the communication terminal 10-2, if the additional information D-5 associated with the identification information of the cow B-2 is received from the server 20 by the communication unit 230, the display control unit 111 controls display of the additional information D-5. In the example illustrated in FIG. 25, the additional information D-5 is AR-displayed to extend from the icon G-1, but it is desirable that the additional information D-5 be displayed on the basis of the position of the cow B-1.

In a case in which the confirmation part highlighted by the highlighting display is examined by the veterinarian M, treatment corresponding to a symptom is performed, and completion of the examination of the confirmation part by the veterinarian M is detected by the detecting unit 120, the process control unit 114 may control execution of a process. Here, the process whose execution is controlled by the process control unit 114 is not particularly limited. For example, the process whose execution is controlled by the process control unit 114 may include at least one of a diagnosis result input or a video call start with other devices.

For example, the detection of the completion of the examination of the confirmation part may be detection of a selection manipulation by the veterinarian M. For example, the display control unit 111 controls display of a diagnosis result input button L-4 and a farmer contact button L-5. If the confirmation part indicated by the highlighting display is examined, the veterinarian M performs the selection manipulation on either the diagnosis result input button L-4 or the farmer contact button L-5. In a case in which the selection manipulation by the veterinarian M is detected by the detecting unit 120, the process control unit 114 may select a process on the basis of the selection manipulation by the veterinarian M and control execution of the selected process.

In a case in which the selection manipulation by the veterinarian M on the diagnosis result input button L-4 is detected by the detecting unit 120, if the diagnosis result input by the veterinarian M is detected by the detecting unit 120, the process control unit 114 performs control such that the diagnosis result is transmitted to the server 20 by the communication unit 130. For example, the diagnosis result may be input by voice. In the server 20, in a case in which the diagnosis result is received by the communication unit 230, the storage unit 220 stores the diagnosis result in an electronic chart of the cow information (data in the database) in association with the identification information of the cow B-2.

Further, the diagnosis result may be used as the correct data of the machine learning process for performing the state estimation on the basis of the sensor data. The machine learning process can be executed by the processing unit (machine learning control unit) 212 in the server 20. Specifically, the diagnosis result by the veterinarian M may be used as the correct data of the machine learning process by the processing unit (machine learning control unit) 212 in the server 20. At this time, the diagnosis result obtained in the communication terminal 10-2 in the past may also be used as the correct data of the machine learning process.

In a case in which the selection manipulation by the veterinarian M on the farmer contact button L-5 is detected by the detecting unit 120, the process control unit 114 may initiate the video call with the communication terminal 10-1 used by the farmer K. A conversation is performed between the veterinarian M and the farmer K through the video call. According to this function, the veterinarian M is able to talk with the farmer K which is in a remote place in a hands-free manner.

Further, the highlighting display may interfere with the examination by the veterinarian M. In this regard, it is desirable that the highlighting display can be deleted by a predetermined deletion manipulation by the veterinarian M. In other words, in the communication terminal 10-2, in a case in which the predetermined deletion manipulation by the veterinarian M is detected by the detecting unit 120, the display control unit 111 may delete the highlighting display. The predetermined deletion manipulation is not limited and may be a predetermined voice input.

Next, a case in which, similarly to the selection of the icon G-2 corresponding to the state “estrus confirmation” by the communication terminal 10-1, the communication terminal 10-2 selects the icon G-2 corresponding to the state “estrus confirmation” is assumed. In order to perform the estrus diagnosis of the cow B-1 corresponding to the state “estrus confirmation,” the veterinarian M moves to a position at which the vulva of the cow B-1 can be visually recognized.

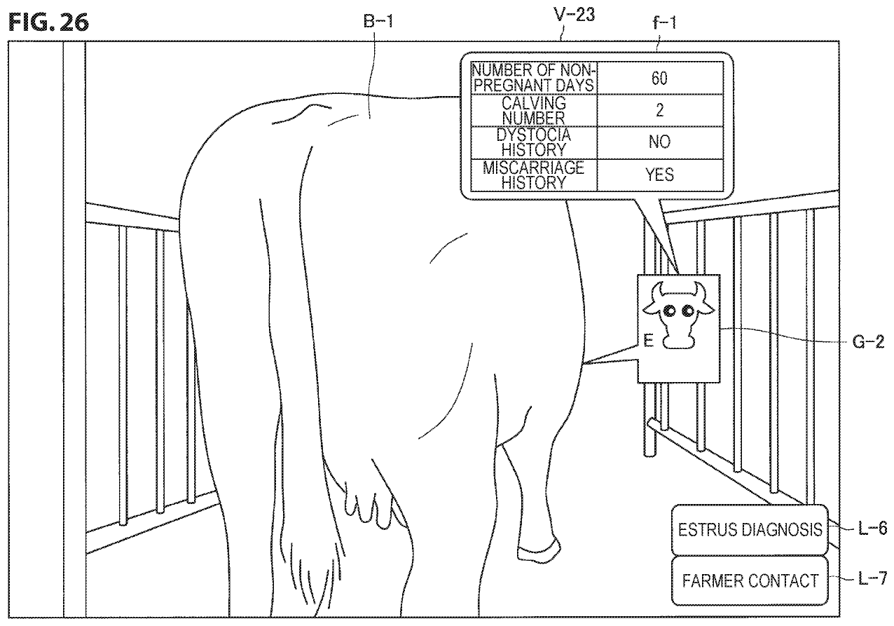

FIG. 26 is a diagram illustrating an example of the field of view of the veterinarian M including the vulva of the cow B-1 corresponding to the state “estrus confirmation.” As illustrated in FIG. 26, in a case in which the vulva of the cow B-1 is in the field of view V-23 of the veterinarian M, the display control unit 111 may generate the information f-1 related to birthing on the basis of the individual information of the cow B-1 corresponding to the state “estrus confirmation” received from the server 20 by the communication unit 130 and control the display of the information f-1 related to birthing.

In a case in which the examination is performed by the veterinarian M (a treatment corresponding to a symptom is performed), and the completion of the examination by the veterinarian M is detected by the detecting unit 120, the process control unit 114 may controls execution of a process. Here, the process whose execution is controlled by the process control unit 114 is not particularly limited. For example, the process whose execution is controlled by the process control unit 114 may include at least one of an estrus diagnosis result input or a video call start with other devices.

For example, the detection of the completion of the examination may be detection of a selection manipulation by the veterinarian M. For example, the display control unit 111 controls display of an estrus diagnosis button L-6 and a farmer contact button L-7. If the examination is performed, the veterinarian M performs the selection manipulation on either of the estrus diagnosis button L-6 and the farmer contact button L-7. In a case in which the selection manipulation by the veterinarian M is detected by the detecting unit 120, the process control unit 114 may select a process on the basis of the selection manipulation by the veterinarian M and control the execution of the selected process.

In a case in which the selection manipulation by the veterinarian M on the estrus diagnosis button L-6 is detected by the detecting unit 120, if the estrus diagnosis result input by the veterinarian M is detected by the detecting unit 120, the process control unit 114 performs control such that the estrus diagnosis result is transmitted to the server 20 by the communication unit 130. For example, the estrus diagnosis result may be input by voice. Further, the estrus diagnosis result may be either “strong,” “medium,” “weak,” or “none.” In the server 20, in a case in which the estrus diagnosis result is received by the communication unit 230, the storage unit 220 stores the estrus diagnosis result in the electronic chart of the cow information (data in the database) in association with the identification information of the cow B-2.

Further, the estrus diagnosis result may be used as the correct data of the machine learning process for performing the state estimation on the basis of the sensor data. The machine learning process can be executed by the processing unit (machine learning control unit) 212 in the server 20. Specifically, the estrus diagnosis result by the veterinarian M may be used as the correct data of the machine learning process by the processing unit (machine learning control unit) 212 in the server 20. At this time, the estrus diagnosis result obtained in the communication terminal 10-2 in the past may also be used as the correct data of the machine learning process.

Further, in a case in which it is confirmed that the cow B-1 is estrus as a result of examining the cow B-1 corresponding to the state “estrus confirmation,” the veterinarian M may perform the artificial insemination on the cow B-1. Furthermore, in a case in which it is confirmed that the cow B-1 has already been artificially inseminated, the veterinarian M may perform a pregnancy test and sex determination. If the results of the pregnancy test and the sex determination input by the veterinarian M are detected by the detecting unit 120, the process control unit 114 performs control such that the results of the pregnancy test and the sex determination are transmitted to the server 20 by the communication unit 130. For example, the results of the pregnancy test and the sex determination may be input by voice. In the server 20, in a case in which the results of the pregnancy test and the sex determination are received by the communication unit 230, the storage unit 220 stores the results of the pregnancy test and the sex determination in the electronic chart of the cow information (data in the database) in association with the identification information of the cow B-1.

In a case in which the selection manipulation by the veterinarian M on the farmer contact button L-7 is detected by the detecting unit 120, the process control unit 114 controls execution of a process similar to the case in which the selection manipulation by the veterinarian M on the farmer contact button L-5 is detected by the detecting unit 120. In other words, in a case in which the selection manipulation by the veterinarian M on the farmer contact button L-7 is detected by the detecting unit 120, the process control unit 114 may start the video call with the communication terminal 10-1 used by the farmer K.

The functions of communication terminal 10-2 used by the veterinarian M have mainly been described above.

### (1.6.3. Map Display)

The example in which, in the communication terminal 10-1, the display control unit 111 controls the AR display of the icon corresponding to the state of the cow has mainly been described above. However, in the communication terminal 10-1, the display control unit 111 may perform control such that the state of the cow is displayed in another form. For example, in the communication terminal 10-1, the display control unit 111 may attach a predetermined mark to a position at which the cow is located in a map and control display of the map in which a predetermined mark is attached to the position at which the cow is located. Further, here, the map display in the communication terminal 10-1 will be mainly described, but the communication terminal 10-2 may also control the map display, similarly to the communication terminal 10-1.

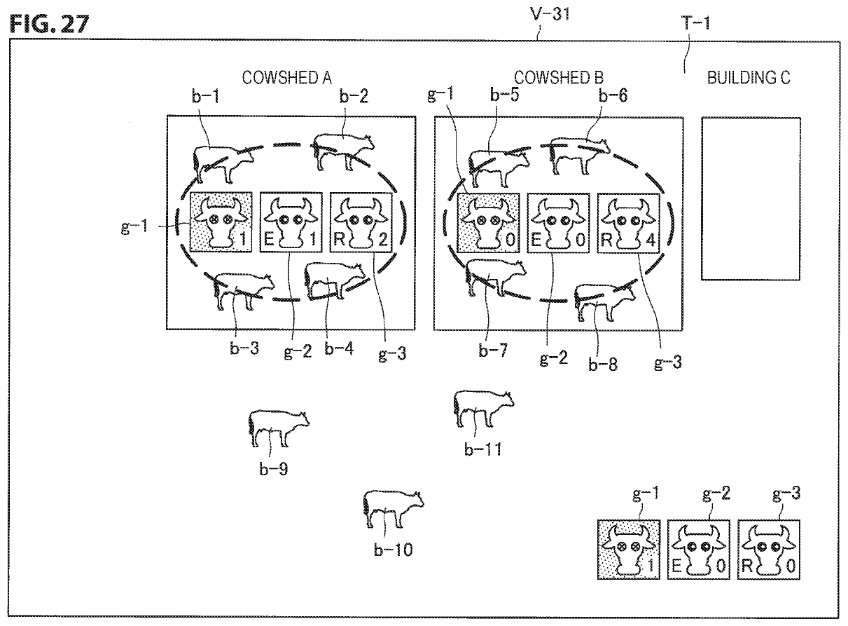

FIG. 27 is a diagram illustrating an example of the map display. Referring to FIG. 27, a field of view V-31 of the farmer K is illustrated. As illustrated in FIG. 27, in the communication terminal 10-1, the display control unit 111 may calculate a headcount of the cows corresponding to the state “abnormality confirmation” on the basis of the position information of each of the cows B-1 to B-11 for each region (for example, a cowshed A, a cowshed B, a region outside the shed, or the like) and perform control such that a map T-1 in which an icon g-1 in which the headcount of the cows corresponding to the state “abnormality confirmation” is attached to a predetermined position (a lower right in the example illustrated in FIG. 27) is attached to each region is displayed.

Similarly, the display control unit 111 may calculate a headcount of the cows corresponding to the state “estrus confirmation” for each region and attach an icon g-2 in which the headcount of the cows corresponding to the state “estrus confirmation” is attached to a predetermined position for each region in the map T-1. Further, the display control unit 111 may calculate a headcount of the cows corresponding to the state “periodic measurement” for each region and attach an icon g-3 in which the headcount of the cows corresponding to the state “periodic measurement” is attached to a predetermined position for each region in the map T-1.

Further, as illustrated in FIG. 27, the display control unit 111 may attach marks b-1 to b-11 to positions at which the cows B-1 to B-11 are located in the map T-1 on the basis of the position information of each of the cows B-1 to B-11. Although the marks b-1 to b-11 are images of the cows in the example illustrated in FIG. 27, a type (for example, a shape, a color, or the like) of the marks b-1 to b-11 is not particularly limited.

A timing at which the map T-1 is displayed is not particularly limited. For example, the display control unit 111 may determine whether or not any one of the cows B-1 To BN is in the field of view V-31 on the basis of the position information of each of the cows B-1 to B-N and the direction of the communication terminal 10-1 (the direction of the face of the farmer K). Then, in a case in which the display control unit 111 determines that none of the cows B-1 to B-N is in the field of view V-31, the display control unit 111 may control display of the map T-1.

Alternatively, in a case in which it is determined that the farmer K performs a predetermined action on the basis of a motion of the farmer K detected by the motion sensor included in the detecting unit 120, the display control unit 111 may control display of the map T-1. The predetermined action may be an action of the farmer K of looking up (that is, an action of tilting the top of the head of the farmer K backward) or an action of the farmer K of looking down (that is, an action of tilting the top of the head of the farmer K forward).

Alternatively, the display control unit 111 may determine whether or not the farmer K is in a predetermined region on the basis of the position information of the farmer K. Further, in a case in which it is determined that the farmer K is in the predetermined region, the display control unit 111 may control the display of the map T-1. The predetermined region is not particularly limited. For example, the predetermined region may be a region in which it is difficult for any of the cows B-1 to B-N to be in the field of view V-31 of the farmer K or may be an office or the like.

Further, FIG. 27 illustrates the example in which the map T-1 is displayed on the entire field of view V-31 of the farmer K. However, the map T-1 may be displayed in a part of the field of view V-31 of the farmer K. At this time, something may be displayed in the field of view other than a region in which the map T-1 is displayed out of the field of view V-31 of the farmer K. For example, the display control unit 111 may perform control such that the icon G is AR-displayed in the field of view other than the region in which the map T-1 is displayed.

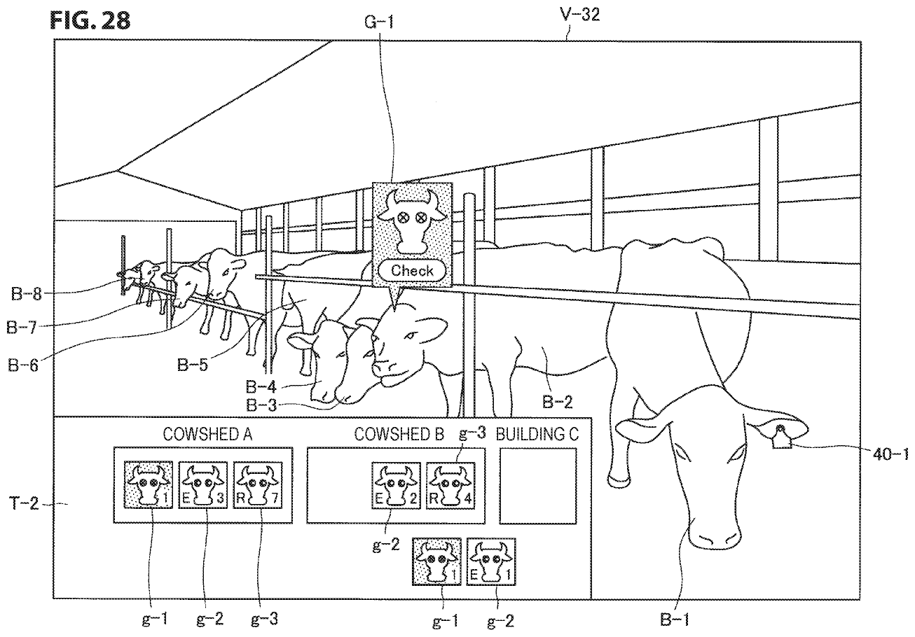

FIG. 28 is a diagram illustrating an example in which the map display and the AR display are simultaneously performed. A field of view V-32 of the farmer K is illustrated. As illustrated in FIG. 28, in the communication terminal 10-1, the display control unit 111 may calculates the headcount of the cows corresponding to each state for each region and perform control such that a map T-2 in which the icons g-1 to g-3 in which the headcount of the cows corresponding to each state is attached to a predetermined position is attached for each region is displayed. Further, the display control unit 111 may control display of the map T-2 and control the AR display of the icon G-1 corresponding to the state “abnormal state” in the cow B-2.

The map display has mainly been described above.

### (1.6.4. Operation Examples)

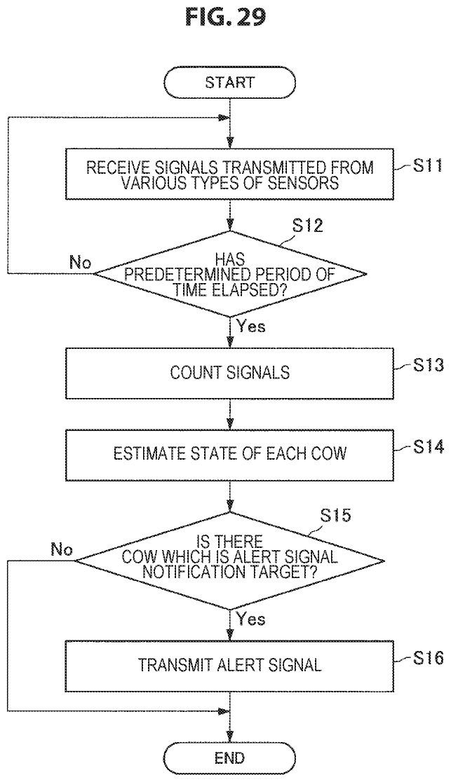

Next, an example of an operation of the display control system 1 according to an embodiment of the present disclosure will be described. FIG. 29 is a flowchart illustrating an example of the operation of the server 20 according to an embodiment of the present disclosure. Further, the flowchart illustrated in FIG. 29 merely illustrates an example of the operation of the server 20. Therefore, the operation of the server 20 is not limited to the operation example of the flowchart illustrated in FIG. 29.

As illustrated in FIG. 29, in the server 20, the communication unit 230 receives signals transmitted from various sensors (S11). Examples of various sensors include the external sensor 30 and the wearable devices 40-1 to 40-N. In a case in which a predetermined period of time has not elapsed (“No” in S12), the control unit 210 returns to S11. On the other hand, in a case in which the predetermined period of time has elapsed (“Yes” in S12), the information acquiring unit 211 acquires the signals received from various sensors until a predetermined time elapses, and the processing unit 212 counts the signals acquired by the information acquiring unit 211 (S13).

The processing unit 212 estimates the state of each cow by the counting (S14). The processing unit 212 determines whether or not there is a cow which is an alert signal notification target on the basis of the state of each cow. The cow which is an alert signal notification target is not limited but may be a cow corresponding to a state “injured” as an example. In a case in which there is no cow that is an alert signal notification target (“No” in S15), the processing unit 212 ends the operation. On the other hand, in a case in which there is a cow that is an alert signal notification target (“Yes” in S15), the communication unit 230 transmits an alert signal to the communication terminal 10-1 (S16).

Here, the processing unit 212 may include the identification information of the cow that is an alert signal notification target and the state of the cow in the alert signal. Further, in the communication terminal 10-1, in a case in which the alert signal is received by the communication unit 130, the display control unit 111 may acquire the identification information of the cow and the state of the cow from the alert signal and control display of the identification information of the cow and the state of the cow.

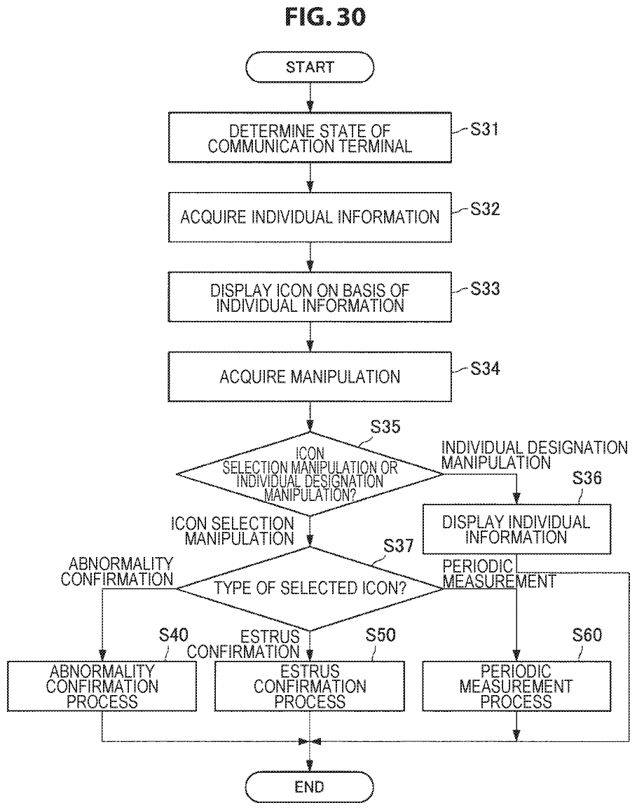

FIG. 30 is a flowchart illustrating an example of an overall operation of the communication terminal 10-1 according to an embodiment of the present disclosure. Further, the flowchart illustrated in FIG. 30 merely illustrates an example of the overall operation of the communication terminal 10-1. Therefore, the overall operation of the communication terminal 10-1 is not limited to the operation example of the flowchart illustrated in FIG. 30. Further, a part (for example, all or some of S31, S34, S35, and S37) of the operation illustrated in FIG. 30 may be executed by the server 20 instead of the communication terminal 10-1. S40 to S60 will be described later.

As illustrated in FIG. 30, in the communication terminal 10-1, the display control unit 111 determines the state of the communication terminal 10-1 (S31). Examples of the state of the communication terminal 10-1 include the position information of the communication terminal 10-1 and the direction of the communication terminal 10-1. Then, if the communication unit 130 transmits the state of the communication terminal 10-1 to the server 20, the server 20 decides the individual information of one or more of cows located in the field of view of the farmer on the basis of the state of the communication terminal 10-1. The display control unit 111 acquires the decided individual information from the server 20 via the communication unit 130 (S32).

Then, the display control unit 111 controls the display of the icon on the basis of the individual information of the cow (S33). More specifically, the display control unit 111 determines whether or not there is a cow corresponding to a predetermined state with reference to the individual information of the cow, and in a case in which there is a cow corresponding to a predetermined state, the display control unit 111 controls the AR display of the icon corresponding to the predetermined state. Here, the abnormality confirmation, the estrus confirmation, and the periodic measurement are assumed as the predetermined states.

Then, the control unit 110 acquires the manipulation of the farmer K (S34). The control unit 110 determines whether the manipulation of the farmer K is an icon selection manipulation (that is, a selection manipulation on an icon) or an individual designation manipulation (that is, a designation manipulation on a cow) (S35). In a case in which the manipulation of the farmer K is the individual designation manipulation (“individual designation manipulation” in S35), the display control unit 111 controls the display of the individual information (S36) and ends the operation. On the other hand, in a case in which the manipulation of the farmer K is the icon selection manipulation (“icon selection manipulation” in S35), the display control unit 111 proceeds to S37.

Then, in a case in which the type of selected icon is the abnormality confirmation (“abnormality confirmation” in S37), the control unit 110 controls execution of an abnormality confirmation process (S40) and ends the operation. On the other hand, in a case in which the type of selected icon is the estrus confirmation (“estrus confirmation” in S37), the control unit 110 controls execution of an estrus confirmation process (S50) and ends the operation. In a case in which the type of selected icon is the periodic measurement (“periodic measurement” in S37), the control unit 110 controls execution of a periodic measurement process (S60) and ends the operation. S40 to S60 will be described below in detail.

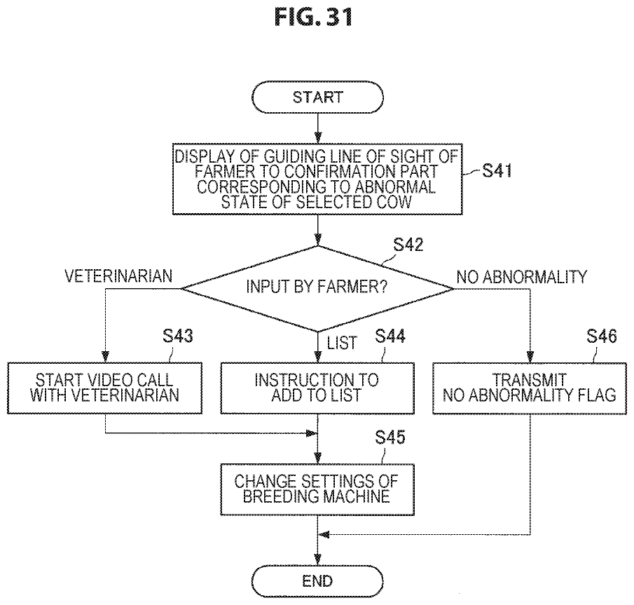

FIG. 31 is a flowchart illustrating an example of the operation of the abnormality confirmation process S40 by the communication terminal 10-1 according to an embodiment of the present disclosure. Further, the flowchart illustrated in FIG. 31 merely illustrates an example of the operation of the abnormality confirmation process S40 by the communication terminal 10-1. Therefore, the operation of the abnormality confirmation process S40 by the communication terminal 10-1 is not limited to the operation example of the flowchart illustrated in FIG. 31. Further, a part (for example, all or some of S42 to S46) of the operation illustrated in FIG. 31 may be executed by the server 20 instead of the communication terminal 10-1.

As illustrated in FIG. 31, in the communication terminal 10-1, the display control unit 111 controls display of guiding the line of sight of the farmer K to the confirmation part corresponding to the abnormal state of the cow whose icon is selected (S41). At this time, the display control unit 111 may control different display depending on whether or not the confirmation part is in the field of view of the farmer K. For example, the display control unit 111 may control the highlighting display (for example, the AR display) for the confirmation part in a case in which the confirmation part is in the field of view of the farmer K. On the other hand, the display control unit 111 may control the display of the still image or the moving image associated with the abnormal state in a case in which the confirmation part is not in the field of view of the farmer K.

Then, the process control unit 114 determines an input by the farmer K (S42). In a case in which the selection manipulation on the veterinarian contact button L-1 is detected by detecting unit 120 (“veterinarian” in S42), the process control unit 114 starts the video call with the veterinarian M (S43), changes settings of the breeding machine 70 (S45), and ends the operation. The change of the settings of the breeding machine 70 is not particularly limited. For example, the process control unit 114 may control an automatic feeder (feeder) such that a medication is mixed with bait given to the cow (to cure a disease of the cow). Alternatively, the process control unit 114 may control an automatic milking machine such that a milk of a cow does not enter a tank (to prevent milk of a cow with mastitis from being mixed with milk of a healthy cow).

On the other hand, in a case in which the selection manipulation on the list addition button L-2 is detected (“list” in S44), the process control unit 114 gives an instruction to add to the abnormality confirmation list (S44). More specifically, the process control unit 114 may control the communication unit 130 such that the flag information indicating necessary diagnosis is transmitted to the server 20. In the server 20, in a case in which the flag information indicating the necessary diagnosis is received by the communication unit 230, the storage unit 220 may store the flag information indicating the necessary diagnosis in association with the identification information of the cow in the abnormal state. Then, the process control unit 114 changes the settings of the breeding machine 70 (S45) and ends the operation.

In a case in which the selection manipulation on the no abnormality button L-3 is detected (“no abnormality” in S42), the process control unit 114 may control the communication unit 130 such that a no abnormality flag (that is, the flag information indicating that there is no abnormality) is transmitted to the server 20. In the server 20, in a case in which the flag information indicating that there is no abnormality is received by the communication unit 230, the storage unit 220 may store the flag information indicating that there is no abnormality in association with the identification information of the cow in the abnormal state. Then, the process control unit 114 ends the operation.

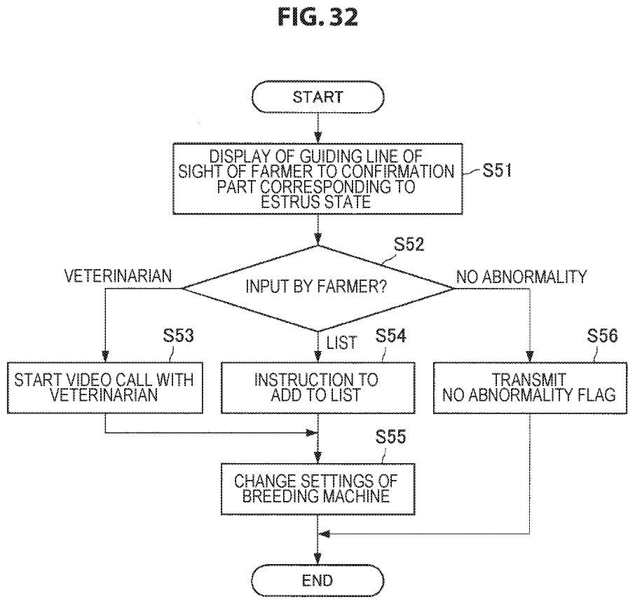

FIG. 32 is a flowchart illustrating an example of the operation of the estrus confirmation process S50 by the communication terminal 10-1 according to an embodiment of the present disclosure. Further, the flowchart illustrated in FIG. 32 merely illustrates an example of the operation of the estrus confirmation process S50 by the communication terminal 10-1. Therefore, the operation of the estrus confirmation process S50 by the communication terminal 10-1 is not limited to the operation example of the flowchart illustrated in FIG. 32. Further, a part (for example, all or some of S52 to S56) of the operation illustrated in FIG. 32 may be executed by the server 20 instead of the communication terminal 10-1.

As illustrated in FIG. 32, in the communication terminal 10-1, the display control unit 111 controls display of guiding the line of sight of the farmer K to the confirmation part corresponding to the estrus state of the cow whose icon is selected (S51). At this time, the display control unit 111 may control different display depending on whether or not the confirmation part is in the field of view of the farmer K. For example, the display control unit 111 may control the highlighting display (for example, the AR display) for the confirmation part in a case in which the confirmation part is in the field of view of the farmer K. On the other hand, the display control unit 111 may control the display of the still image or the moving image associated with the estrus state in a case in which the confirmation part is not in the field of view of the farmer K.

Then, the process control unit 114 determines an input by the farmer K (S52). In a case in which the selection manipulation on the veterinarian contact button L-1 is detected by the detecting unit 120 (“veterinarian” in S52), the process control unit 114 starts the video call with the veterinarian M (S53), changes the settings of the breeding machine 70 (S55), and ends the operation. The change of the settings of the breeding machine 70 is not particularly limited. For example, the process control unit 114 may control a gate such that the cow in the estrus state is guided to a different area from that of the other cows. Alternatively, the process control unit 114 may control the automatic feeder such that an amount of feeding by the automatic feeder is an amount of feeding corresponding to the estrus state.

On the other hand, in a case in which the selection manipulation on the list addition button L-2 is detected (“list” in S54), the process control unit 114 gives an instruction to add to the artificial insemination list (S54). More specifically, the process control unit 114 may control the communication unit 130 such that the flag information indicating necessary of the artificial insemination is transmitted to the server 20. In the server 20, in a case in which the flag information indicating the necessary diagnosis is received by the communication unit 230, the storage unit 220 may store the flag information indicating the necessary of the artificial insemination in association with the identification information of the cow in the estrus state. Then, the process control unit 114 changes the settings of the breeding machine 70 (S55) and ends the operation.

In a case in which the selection manipulation on the no abnormality button L-3 is detected (“no abnormality” in S52), the process control unit 114 may control the communication unit 130 such that a no abnormality flag (that is, the flag information indicating that there is no abnormality) is transmitted to the server 20. In the server 20, in a case in which the flag information indicating that there is no abnormality is received by the communication unit 230, the storage unit 220 may store the flag information indicating that there is no abnormality in association with the identification information of the cow in the estrus state. Then, the process control unit 114 ends the operation.

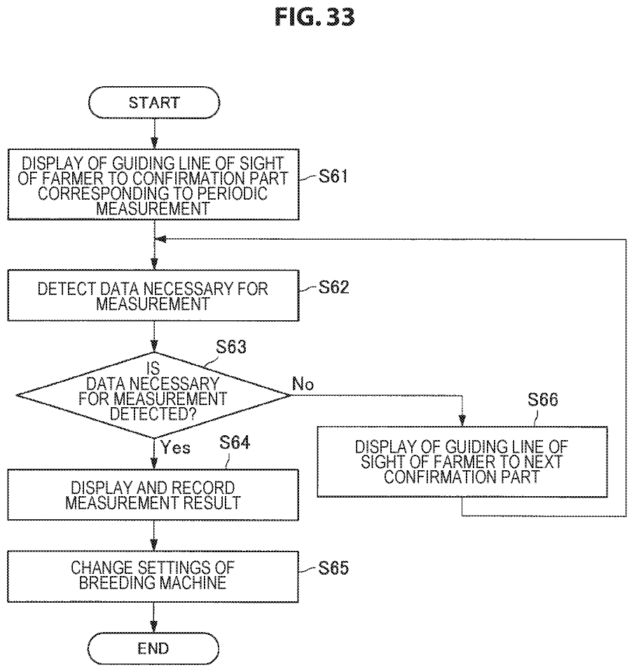

FIG. 33 is a flowchart illustrating an example of the operation of the periodic measurement process S60 by the communication terminal 10-1 according to an embodiment of the present disclosure. Further, the flowchart illustrated in FIG. 33 merely illustrates an example of the operation of the periodic measurement process S60 by the communication terminal 10-1. Therefore, the operation of the periodic measurement process S60 by the communication terminal 10-1 is not limited to the operation example of the flowchart illustrated in FIG. 33. Further, a part (for example, all or some of S62 to S65) of the operation illustrated in FIG. 33 may be executed by the server 20 instead of the communication terminal 10-1.

As illustrated in FIG. 33, in the communication terminal 10-1, the display control unit 111 controls display of guiding the line of sight of the farmer K to the confirmation part corresponding to the periodic measurement of the cow whose icon is selected (S61). At this time, the display control unit 111 may control different display depending on whether or not the confirmation part is in the field of view of the farmer K. For example, the display control unit 111 may control the highlighting display (for example, the AR display) for the confirmation part in a case in which the confirmation part is in the field of view of the farmer K. On the other hand, the display control unit 111 may control the display of the still image or the moving image associated with the periodic measurement in a case in which the confirmation part is not in the field of view of the farmer K.

Then, the detecting unit 120 attempts to detect data necessary for measurement (S62), and in a case in which the data necessary for the measurement is not detected by the detecting unit 120 (“No” in S63), the display control unit 111 controls display of guiding the line of sight of the farmer to the next confirmation part (S66) and proceeds to S62. On the other hand, in a case in which the data necessary for the measurement is detected by the detecting unit 120 (“Yes” in S63), the display control unit 111 controls the display of the measurement result, and the process control unit 114 controls the record of the measurement result (S64). The measurement result is transmitted to the server 20 by the communication unit 130 and stored in the storage unit 220 in the server 20.

Then, the process control unit 114 changes the settings of the breeding machine 70 (S65) and ends the operation. Here, the change of the settings of the breeding machine 70 is not particularly limited. For example, the process control unit 114 may control the automatic feeder such that the amount of feeding is changed depending on the measurement result. More specifically, the process control unit 114 may control the automatic feeder such that the amount of feeding is reduced in a case in which the BCS exceeds a first threshold value. On the other hand, the process control unit 114 may control the automatic feeder such that the amount of feeding is increased in a case in which the BCS is less than a second threshold value.

Further, for example, the process control unit 114 may control the automatic milking machine such that the amount of milking is changed in accordance with the measurement result. More specifically, in a case in which the BCS exceeds a third threshold value, the automatic milking machine may be controlled to increase the amount of milking. On the other hand, in a case in which the BCS is less than a fourth threshold value, the process control unit 114 may control the automatic milking machine such that the milking amount becomes zero.

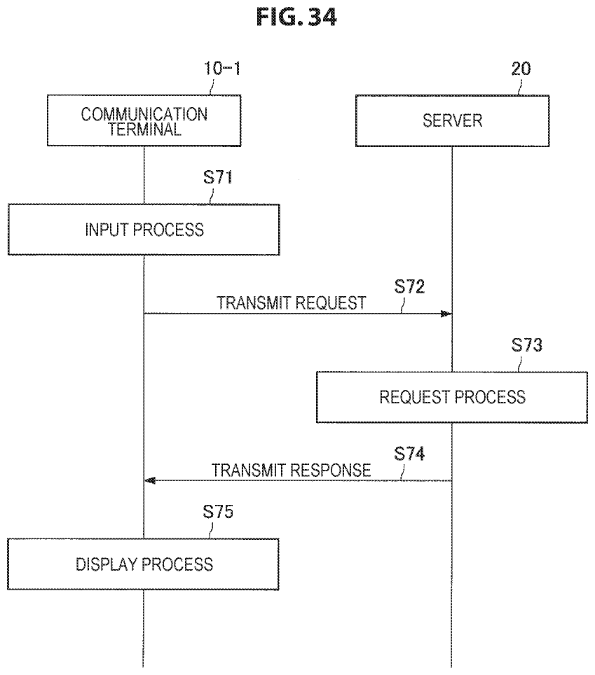

FIG. 34 is a flowchart illustrating the example of the operation of the display control system 1 according to an embodiment of the present disclosure. Further, the flowchart illustrated in FIG. 34 merely indicates an example of the operation of the display control system 1. Therefore, the operation of the display control system 1 is not limited to the operation example of the flowchart illustrated in FIG. 34.

As illustrated in FIG. 34, in the communication terminal 10-1, an input process is executed by the detecting unit 120 (S71). An example of the input process includes detection of the state (the position information and the direction) of the communication terminal 10-1. Then, the communication unit 130 transmits a request corresponding to the input process to the server 20 (S72). For example, the request may include the state of the communication terminal 10-1.

Then, in the server 20, if the request is received by the communication unit 230, the control unit 210 executes a process for the request (S73). For example, as the process for the request, the information acquiring unit 211 may acquire the individual information of the cow located in the field of view of the farmer on the basis of the state of the communication terminal 10-1 and the position information of each cow.

In the server 20, in a case in which a response based on a processing result is transmitted by the communication unit 230 (S74), the response is received by the communication unit 130 in the communication terminal 10-1. For example, the response may include the individual information of the cow located in the field of view of the farmer. Further, a display process based on the response is executed by the output unit 160 (S75). The display process may be a process of displaying an icon based on the individual information of the cow located in the field of view of the farmer.

The example of the operation of the display control system 1 according to an embodiment of the present disclosure has been described above.

### [1.7. Hardware Configuration Example]

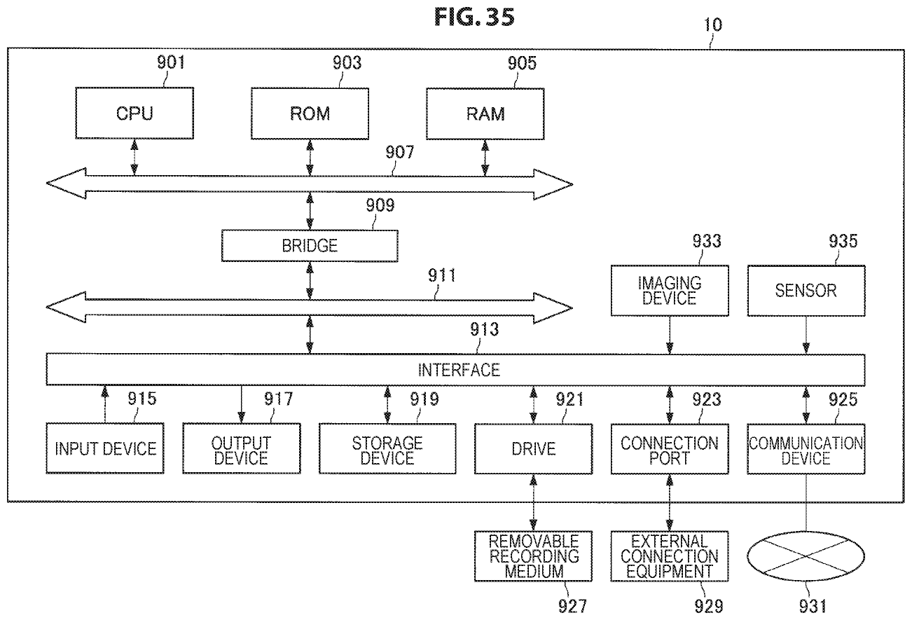

Next, with reference to FIG. 35, a hardware configuration of the communication terminal 10 according to the embodiment of the present disclosure will be described. FIG. 35 is a block diagram illustrating the hardware configuration example of the communication terminal 10 according to the embodiment of the present disclosure. Further, the hardware configuration of the server 20 according to an embodiment of the present disclosure can be realized, similarly to the hardware configuration example of the communication terminal 10 illustrated in FIG. 35.

As illustrated in FIG. 35, the communication terminal 10 includes a central processing unit (CPU) 901, read only memory (ROM) 903, and random access memory (RAM) 905. The control unit 110 can be realized by the CPU 901, the ROM 903 and the ROM 905. In addition, the communication terminal 10 may include a host bus 907, a bridge 909, an external bus 911, an interface 913, an input device 915, an output device 917, a storage device 919, a drive 921, a connection port 923, and a communication device 925. Moreover, the communication terminal 10 may include an imaging device 933 and a sensor 935, as necessary. The communication terminal 10 may include a processing circuit such as a digital signal processor (DSP) or an application specific integrated circuit (ASIC), alternatively or in addition to the CPU 901.

The CPU 901 serves as an arithmetic processing device and a control device, and controls the overall operation or a part of the operation of the communication terminal 10 according to various programs recorded in the ROM 903, the RAM 905, the storage device 919, or a removable recording medium 927. The ROM 903 stores programs, operation parameters, and the like used by the CPU 901. The RAM 905 temporarily stores programs used when the CPU 901 is executed, and parameters that change as appropriate when executing such programs. The CPU 901, the ROM 903, and the RAM 905 are connected with each other via the host bus 907 configured from an internal bus such as a CPU bus. In addition, the host bus 907 is connected to the external bus 911 such as a Peripheral Component Interconnect/Interface (PCI) bus via the bridge 909.

The input device 915 is a device operated by a user such as a button. The input device 915 may include a mouse, a keyboard, a touchscreen, a button, a switch, a lever and the like. The input device 915 may include a microphone configured to detect voice of users. The input device 915 may be a remote control device that uses, for example, infrared radiation and another type of radio waves. Alternatively, the input device 915 may be external connection equipment 929 such as a mobile phone that corresponds to an operation of the communication terminal 10. The input device 915 includes an input control circuit that generates input signals on the basis of information which is input by a user to output the generated input signals to the CPU 901. A user inputs various types of data and indicates a processing operation to the communication terminal 10 by operating the input device 915. In addition, the imaging device 933 (to be described later) may function as the input device by capturing an image of movement of hands of a user or capturing a finger of a user. In this case, a pointing position may be decided in accordance with the movement of the hands or a direction of the finger. Further, the detecting unit 120 can be realized by the input device 915.

The output device 917 includes a device that can visually or audibly report acquired information to a user. The output device 917 may be, for example, a display device such as a liquid crystal display (LCD), an organic electro-luminescence (EL), a sound output device such as a speaker or a headphone, or the like. Further, the output device 917 may include a plasma display panel (PDP), a projector, a hologram, a printer, or the like. The output device 917 outputs a result obtained through a process performed by the communication terminal 10, in the form of text or video such as an image, or sounds such as voice and audio sounds. In addition, the output device 917 may include a light or the like to light the surroundings. Further, the output unit 160 can be realized by the output device 917.

The storage device 919 is a device for data storage that is an example of the storage unit of the communication terminal 10. The storage device 919 includes, for example, a magnetic storage device such as a hard disk drive (HDD), a semiconductor storage device, an optical storage device, or a magneto-optical storage device. The storage device 919 stores therein various data and programs executed by the CPU 901, and various data acquired from an outside.

The drive 921 is a reader/writer for the removable recording medium 927 such as a magnetic disk, an optical disc, a magneto-optical disk, and a semiconductor memory, and built in or externally attached to the communication terminal 10. The drive 921 reads out information recorded on the mounted removable recording medium 927, and outputs the information to the RAM 905. The drive 921 writes the record into the mounted removable recording medium 927.

The connection port 923 is a port used to directly connect equipment to the communication terminal 10. The connection port 923 may be a USB (Universal Serial Bus) port, an IEEE1394 port, and a Small Computer System Interface (SCSI) port, or the like. In addition, the connection port 923 may be an RS-232C port, an optical audio terminal, an HDMI (registered trademark) (High-Definition Multimedia Interface) port, and so on. The connection of the external connection equipment 929 to the connection port 923 makes it possible to exchange various kinds of data between the communication terminal 10 and the external connection equipment 929.

The communication device 925 is a communication interface including, for example, a communication device for connection to the network 931. The communication device 925 may be, for example, a wired or wireless local area network (LAN), Bluetooth (registered trademark), or a communication card for a wireless USB (WUSB). The communication device 925 may also be, for example, a router for optical communication, a router for asymmetric digital subscriber line (ADSL), or a modem for various types of communication. For example, the communication device 925 transmits and receives signals in the Internet or transmits signals to and receives signals from another communication device by using a predetermined protocol such as TCP/IP. The network 931 to which the communication device 925 connects is a network established through wired or wireless connection. The network 931 is, for example, the Internet, a home LAN, infrared communication, radio communication, or satellite communication. Further, the communication unit 130 can be realized by the communication device 925.

The imaging device 933 is a device that captures images of a real space by using an image sensor such as a charge coupled device (CCD) or a complementary metal oxide semiconductor (CMOS), and various members such as a lens for controlling image formation of a subject image onto the image sensor, and generates the captured images. The imaging device 933 may capture a still image or a moving image. Further, the detecting unit 120 can be realized by the imaging device 933.

The sensor 935 is various sensors such as a ranging sensor, an acceleration sensor, a gyro sensor, a geomagnetic sensor, a vibration sensor, an optical sensor, and a sound sensor. The sensor 935 acquires information regarding a state of the communication terminal 10 such as a posture of a housing of the communication terminal 10, and information regarding an environment surrounding the communication terminal 10 such as luminous intensity and noise around the communication terminal 10. The sensor 935 may include a global positioning system (GPS) sensor that receives GPS signals to measure latitude, longitude, and altitude of the device. Further, the detecting unit 120 can be realized by the sensor 935.

### 2. CONCLUSION

As described above, according to an embodiment of the present disclosure, a display control device including a display control unit configured to perform control such that an image corresponding to a state of a management target object located in a field of view of a user is displayed at a position having a predetermined positional relation with a position of the management target object, in which, in a case in which the image is selected, the display control unit controls guidance display of giving guidance of causing the user to visually recognize a confirmation part corresponding to the state in the management target object is provided. Accordingly, it is possible to provide a technique capable of easily managing the target objects.

The preferred embodiment (s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the position of each component is not particularly limited as long as the operations of the communication terminal 10 and the server 20 are realized. Some of the processes of the respective units in the communication terminal 10 may be performed by the server 20. As a specific example, some or all of the blocks (the display control unit 111, the selecting unit 112, the determining unit 113, and the process control unit 114) included in the control unit 110 in the communication terminal 10 may be installed in the server 20 or the like. Further, some of the processes of the respective units in the server 20 may be performed by the communication terminal 10. Further, in addition to the display control device 10 and the server 20, for example, one or more relay devices (not illustrated) that perform the processes of some of the respective units may be installed in the display control system 1. In this case, the relay device may be, for example, a smartphone carried by the user. For example, the relay device includes a communication circuit for communicating with the display control device 10 and the server 20 and a processing circuit for performing some of the processes performed by the respective blocks in the embodiment in the housing of the relay device. Further, when the relay device receives predetermined data from, for example, the communication unit 230 of the server 20, performs the processes of some of the respective units, and transmits data to the communication unit 130 of the display control device 10 on the basis of a processing result or performs communication and processes in an opposite direction, effects similar to those of the embodiment of the operations of the display control device 10 and the server 20 are obtained.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A display control device, including:

a display control unit configured to perform control such that an image corresponding to a state of a management target object located in a field of view of a user is displayed at a position having a predetermined positional relation with a position of the management target object,

in which, in a case in which the image is selected, the display control unit controls guidance display of guiding the user to visually recognize a confirmation part corresponding to the state in the management target object.

(2)

The display control device according to (1), in which the management target object is a farm animal.

(3)

The display control device according to (2), including:

a communication unit configured to transmit confirmation result input data in response to a confirmation result input of the confirmation part by the user after the guidance display is performed,

in which the transmitted confirmation result input data is recorded in association with identification information identifying the farm animal.

(4)

The display control device according to any one of (1) to (3), in which the display control unit controls display of an icon image corresponding to a state category as the image.

(5)

The display control device according to any one of (1) to (4), in which the display control unit performs control such that the image is displayed for a management target object satisfying a first condition among a plurality of the management target objects, and restricts display of the image for the management target object which is in a state in which a second condition different from the first condition is satisfied.

(6)

The display control device according to any one of (1) to (5), including:

a display configured to display an image corresponding to the state of the management target object;

a housing including the display and configured to be wearable on a head of the user; and

a non-contact type sensor configured to detect a selection manipulation of the image corresponding to the state of the management target object.

(7)

The display control device according to (6), in which the non-contact sensor detects at least one of a gesture of the user, a line of sight of the user, or a voice command of the user.

(8)

The display control device according to any one of (1) to (7), in which, in a case in which the confirmation part is not located in the field of view, the display control unit controls auxiliary guidance display of encouraging the user to move to a position at which the confirmation part is able to be visually recognized.

(9)

The display control device according to any one of (1) to (8), in which, in a case in which the confirmation part is located in the field of view, the display control unit controls highlighting display for the confirmation part as the guidance display.

(10)

The display control device according to any one of (1) to (9), in which, in a case in which a distance between the management target object and the user is larger than a predetermined distance, the display control unit controls display of a still image or a moving image associated with the state.

(11)

The display control device according to any one of (1) to (10), in which the display control unit controls display of the image in accordance with a display state corresponding to a priority of the state.

(12)

The display control device according to any one of (1) to (11), in which the display control device includes a selection unit configured to select the image in a case in which a selection manipulation is performed in a state in which a pointer is located at a position of the image or a position near the image.

(13)

The display control device according to (12), in which, in a case in which the pointer is located at the position of the image or the position near the image, the display control unit enlarges the image.

(14)

The display control device according to any one of (1) to (13), in which the display control unit controls display of information indicating display or non-display of the image for each state.

(15)

The display control device according to any one of (1) to (14), in which, in a case in which a state of the management target object corresponds to a position or an action of the user, the display control unit controls display of an image corresponding to the state.

(16)

The display control device according to any one of (1) to (15), in which, in a case in which there is a plurality of states of the management target object, the display control unit selects predetermined states from a plurality of the states of the management target object on the basis of a priority of each of the plurality of states of the management target object and controls display of an image corresponding to each of the predetermined states.

(17)

The display control device according to any one of (1) to (16), in which the display control device includes a process control unit configured to control execution of a process, and

the process includes at least one of a video call start process with another device, a process of adding an ID of the management target object to a list, or a process of adding information indicating that there is no abnormality to the state of the management target object.

(18)

The display control device according to (1), including:

a communication unit configured to transmit confirmation result input data from the user based on the guidance display to a server,

in which the server includes a machine learning control unit configured to perform a machine learning process for estimating the state of the management target object on the basis of sensor data for the management target object, and the confirmation result input data is used as correct data of the machine learning process by the server.

(19)

The display control device according to any one of (1) to (18), in which the display control unit performs control such that the image is displayed in accordance with a size corresponding to a distance between the management target object and the user.

(20)

The display control device according to any one of (1) to (19), in which the display control unit controls display of information related to the management target object in a case in which a predetermined designation manipulation designating the management target object is performed.

(21)

The display control device according to any one of (1) to (20), in which, in a case in which the management target object is not in the field of view, in a case in which the user performs a predetermined action, or in a case in which the user is located in a predetermined region, the display control unit controls display of a map in which a predetermined mark is attached to a position at which the management target object is located.

(22)

The display control device according to any one of (1) to (21), in which, in a case in which there is a plurality of states of the management target object, the display control unit selects predetermined states from a plurality of the states on the basis of a priority of each of the plurality of states and controls display of an image corresponding to each of the predetermined states.

(23)

The display control device according to (17), in which the process control unit selects the process on the basis of a selection result by the user or sensor data.

(24)

A display control method, including:

performing, by a processor, control such that an image corresponding to a state of a management target object located in a field of view of a user is displayed at a position having a predetermined positional relation with a position of the management target object; and

controlling, in a case in which the image is selected, guidance display of guiding the user to visually recognize a confirmation part corresponding to the state in the management target object.

(25)

A program causing a computer to function as a display control device including

a display control unit configured to perform control such that an image corresponding to a state of a management target object located in a field of view of a user is displayed at a position having a predetermined positional relation with a position of the management target object,

in which, in a case in which the image is selected, the display control unit controls guidance display of guiding the user to visually recognize a confirmation part corresponding to the state in the management target object.

### REFERENCE SIGNS LIST

1 display control system
10 communication terminal
110 control unit
111 display control unit
112 selecting unit
113 determining unit
114 process control unit
120 detecting unit
130 communication unit
150 storage unit
160 output unit
20 server
210 control unit
211 information acquiring unit
212 processing unit (machine learning control unit)
213 information providing unit
220 storage unit
230 communication unit
250 storage unit
30 external sensor
310 control unit
320 detecting unit
330 communication unit
350 storage unit
40 wearable device
410 control unit
420 detecting unit
430 communication unit
450 storage unit
50 repeater
60 gateway device
70 breeding machine

1. A display control device, comprising:
a display control unit configured to perform control such that an image corresponding to a state of a management target object located in a field of view of a user is displayed at a position having a predetermined positional relation with a position of the management target object,
wherein, in a case in which the image is selected, the display control unit controls guidance display of guiding the user to visually recognize a confirmation part corresponding to the state in the management target object.

2. The display control device according to claim 1, wherein the management target object is a farm animal.

3. The display control device according to claim 2, comprising:
a communication unit configured to transmit confirmation result input data in response to a confirmation result input of the confirmation part by the user after the guidance display is performed,
wherein the transmitted confirmation result input data is recorded in association with identification information identifying the farm animal.

4. The display control device according to claim 1, wherein the display control unit controls display of an icon image corresponding to a state category as the image.

5. The display control device according to claim 1, wherein the display control unit performs control such that the image is displayed for a management target object satisfying a first condition among a plurality of the management target objects, and restricts display of the image for the management target object which is in a state in which a second condition different from the first condition is satisfied.

6. The display control device according to claim 5, comprising:
a display configured to display an image corresponding to the state of the management target object;
a housing including the display and configured to be wearable on a head of the user; and
a non-contact type sensor configured to detect a selection manipulation of the image corresponding to the state of the management target object.

7. The display control device according to claim 6, wherein the non-contact sensor detects at least one of a gesture of the user, a line of sight of the user, or a voice command of the user.

8. The display control device according to claim 1, wherein, in a case in which the confirmation part is not located in the field of view, the display control unit controls auxiliary guidance display of encouraging the user to move to a position at which the confirmation part is able to be visually recognized.

9. The display control device according to claim 1, wherein, in a case in which the confirmation part is located in the field of view, the display control unit controls highlighting display for the confirmation part as the guidance display.

10. The display control device according to claim 1, wherein, in a case in which a distance between the management target object and the user is larger than a predetermined distance, the display control unit controls display of a still image or a moving image associated with the state.

11. The display control device according to claim 1, wherein the display control unit controls display of the image in accordance with a display state corresponding to a priority of the state.

12. The display control device according to claim 1, wherein the display control device includes a selection unit configured to select the image in a case in which a selection manipulation is performed in a state in which a pointer is located at a position of the image or a position near the image.

13. The display control device according to claim 12, wherein, in a case in which the pointer is located at the position of the image or the position near the image, the display control unit enlarges the image.

14. The display control device according to claim 1, wherein the display control unit controls display of information indicating display or non-display of the image for each state.

15. The display control device according to claim 1, wherein, in a case in which a state of the management target object corresponds to a position or an action of the user, the display control unit controls display of an image corresponding to the state.

16. The display control device according to claim 1, wherein, in a case in which there is a plurality of states of the management target object, the display control unit selects predetermined states from a plurality of the states on a basis of a priority of each of the plurality of states and controls display of an image corresponding to each of the predetermined states.

17. The display control device according to claim 1, wherein the display control device includes a process control unit configured to control execution of a process, and
the process includes at least one of a video call start process with another device, a process of adding an ID of the management target object to a list, or a process of adding information indicating that there is no abnormality to the state of the management target object.

18. The display control device according to claim 1, comprising:
a communication unit configured to transmit confirmation result input data from the user based on the guidance display to a server,
wherein the server includes a machine learning control unit configured to perform a machine learning process for estimating the state of the management target object on a basis of sensor data for the management target object, and the confirmation result input data is used as correct data of the machine learning process by the server.

19. A display control method, comprising:
performing, by a processor, control such that an image corresponding to a state of a management target object located in a field of view of a user is displayed at a position having a predetermined positional relation with a position of the management target object; and
controlling, in a case in which the image is selected, guidance display of guiding the user to visually recognize a confirmation part corresponding to the state in the management target object.

20. A program causing a computer to function as a display control device including
a display control unit configured to perform control such that an image corresponding to a state of a management target object located in a field of view of a user is displayed at a position having a predetermined positional relation with a position of the management target object,
wherein, in a case in which the image is selected, the display control unit controls guidance display of guiding the user to visually recognize a confirmation part corresponding to the state in the management target object.
